(19) United States
(12) Patent Application Publication
(10) Pub. No.: US 2020/0209158 A1
(43) Pub. Date: Jul. 2, 2020

(54) ANALYTICAL TEST DEVICE

(71) Applicant: Sumitomo Chemical Company Limited, Tokyo (JP)

(72) Inventors: Andrey Nikolaenko, Huntington (GB); Matthew Roberts, Godmanchester (GB); May Wheeler, Godmanchester (GB); Nir Yaacobi-Gross, Godmanchester (GB)

(73) Assignee: Sumitomo Chemical Company Limited, Tokyo (JP)

(21) Appl. No.: 16/623,305

(22) PCT Filed: Jun. 13, 2018
(86) PCT No.: PCT/GB2018/051606

§ 371 Date: Dec. 16, 2019

(30) Foreign Application Priority Data
Jun. 16, 2017 (GB) 1709597.7

(51) Int. Cl. G01N 21/64; G01N 21/93; G01N 21/31

(52) U.S. Cl. CPC G01N 21/6428; G01N 2021/6439; G01N 21/31; G01N 21/93

(57) ABSTRACT

An analytical test device (12) includes one or more light emitters (13) configured to emit light within a first range of wavelengths (Δλₐ). The analytical test device (12) also includes one or more first photodetectors (14), each first photodetector (14) being sensitive to a second range of wavelengths (Δλ_{b}) around a first wavelength. The analytical test device (12) also includes one or more second photodetectors (15), each second photodetector (15) being sensitive to a third range of wavelengths (Δλ_{c}) around a second wavelength, the second wavelength being different to the first wavelength. The analytical test device (12) also includes a correction module (16) configured to receive signals (19, 20) from the first and second photodetectors (14, 15) and to generate a corrected signal (21) based on a weighted difference of the signals (19, 20) from the first and second photodetectors (14, 15). The analytical test device (12) is configured such that light from the light emitters (13) reaches the first and second photodetectors (14, 15) via an optical path which includes a sample receiving portion (7).

### FIELD OF THE INVENTION

The present invention relates to an analytical test device.

### BACKGROUND

Biological testing for the presence and/or concentration of an analyte may be conducted for a variety of reasons including, amongst other applications, preliminary diagnosis, screening samples for presence of controlled substances and management of long term health conditions.

Lateral flow devices (also known as “lateral flow immunoassays”) are one variety of biological testing. Lateral flow devices may be used to test a liquid sample, such as saliva, blood or urine, for the presence of an analyte. Examples of lateral flow devices include home pregnancy tests, home ovulation tests, tests for other hormones, tests for specific pathogens and tests for specific drugs. For example, EP 0 291 194 A1 describes a lateral flow device for performing a pregnancy test.

In a typical lateral flow testing strip, a liquid sample is introduced at one end of a porous strip which is then drawn along the strip by capillary action (or “wicking”). A portion of the lateral flow strip is pre-treated with labelling particles which are activated with a reagent which binds to the analyte to form a complex, if the analyte is present in the sample. The bound complexes, and also unreacted labelling particles, continue to propagate along the strip before reaching a testing region which is pre-treated with an immobilised binding reagent which captures bound complexes of analyte and labelling particles and does not capture unreacted labelling particles. The labelling particles have a distinctive colour, or other detectable optical or non-optical property, and the development of a concentration of labelling particles in the test regions provides an observable indication that the analyte has been detected. Lateral flow test strips may be based on, for example, colorimetric labelling using gold or latex nanoparticles, fluorescent marker molecules or magnetic labelling particles.

Another variety of biological testing involves assays conducted in liquids held in a container such as a vial, a PCR well/plate, a cuvette or a microfluidic cell. Liquid assays may be measured based on colorimetry or fluorescence. An advantage of some liquid based assays is that they may allow tests to be conducted using very small (e.g. picolitre) volumes.

Sometimes, merely determining the presence or absence of an analyte is desired, i.e. a qualitative test. In other applications, an accurate concentration of the analyte may be desired, i.e. a quantitative test. For example, WO 2008/101732 A1 describes an optical measuring instrument and measuring device. The optical measuring instrument includes at least one source for providing at least one electromagnetic beam to irradiate a sample and to interact with the specimen within the sample, at least one sensor for detecting an output of the interaction between the specimen and the electromagnetic beam, an integrally formed mechanical bench for the optical and electronic components and a sample holder for holding the sample. The at least one source, the at least one sensor, and the mechanical bench are integrated in one monolithic optoelectronic module and the sample holder can be connected to this module.

### SUMMARY

According to a first aspect of the invention, there is provided an analytical test device including one or more light emitters configured to emit light within a first range of wavelengths. The analytical test device also includes one or more first photodetectors, each first photodetector being sensitive to a second range of wavelengths around a first wavelength. The analytical test device also includes one or more second photodetectors, each second photodetector being sensitive to a third range of wavelengths around a second wavelength which is different to the first wavelength. The analytical test device also includes a correction module configured to receive signals from the first and second photodetectors and to generate a corrected signal based on a weighted difference of the signals from the first and second photodetectors. The analytical test device is configured such that light from the light emitters reaches the first and second photodetectors via an optical path which includes a sample receiving portion.

The analytical test device may be configured such that, in response to a sample being disposed in the sample receiving portion, the first and second photodetectors receive substantially equal quantities of light scattered from each part of the sample within the sample receiving portion. The second and third ranges may not overlap or may not significantly overlap. The optical path may not include any beam-splitters. The optical path may not include any lenses.

A plurality of first photodetectors and a plurality of second photodetectors may be disposed in an alternating pattern.

Each first photodetector or part of each first photodetector may be elongated in a first direction and each second photodetector or part of each second photodetector may be elongated in the first direction. The first and second photodetectors, or parts thereof, may be interdigitated in a second direction substantially perpendicular to the first direction.

A plurality of first photodetectors may be disposed in a first lattice and a plurality of second photodetectors may be disposed in a second lattice. The first and second lattices may be arranged to be interpenetrating.

The optical path may also include an optical diffuser arranged between the sample receiving portion and the photodetectors.

The optical path may be configured such that the first and second photodetectors receive light transmitted through the sample receiving portion.

The optical path may be configured such that the first and second photodetectors receive light reflected from the sample receiving portion.

Each first photodetector may include a first light sensitive material which is sensitive to the second range of wavelengths and each second photodetector may include a second light sensitive material which is sensitive to the third range of wavelengths.

Each first photodetector may include a light sensitive material and a first filter. The first filter may be arranged to filter light arriving via the optical path, to transmit the second range of wavelengths and to attenuate the third range of wavelengths. Each second photodetector may include the light sensitive material and a second filter. The second filter may be arranged to filter light arriving via the optical path, to transmit the third range of wavelengths and to attenuate the second range of wavelengths.

Each first photodetector may include a light sensitive material and each second photodetector may include the light sensitive material. The analytical test device may also include a first filter corresponding to each first photodetector. The first filter may be arranged to filter light arriving via the optical path, to transmit the second range of wavelengths and to attenuate the third range of wavelengths. The analytical test device may also include a second filter corresponding to each second photodetector. The second filter may be arranged to filter light arriving via the optical path, to transmit the third range of wavelengths and to attenuate the second range of wavelengths.

Each first photodetector may include a light sensitive material and a first resonant cavity configured to have a resonance wavelength within the second range of wavelengths. Each second photodetector may include the light sensitive material and a second resonant cavity configured to have a resonance wavelength within the third range of wavelengths.

The light sensitive material may include two or more different materials. The two or more materials may be mixed, compounded, blended and/or arranged to take the form of a layer structure. The light sensitive material may be blend of n-type and p-type organic semiconductors.

Each light emitter may take the form of an organic light emitting diode.

The organic light emitting diode or diodes may be disposed on one or more glass substrates. The organic light emitting diode or diodes may be disposed on one or more plastic substrates.

The first and second photodetectors may take the form of organic photodetectors. The first and second photodetectors may take the form of inorganic photodetectors.

The first and second photodetectors may take the form of top-absorbing organic photodetectors.

The first and second photodetectors may take the form of bottom-absorbing organic photodetectors.

The corrected signal may be generated according to:

$${I}_{C} = {\sum }_{n = 1}^{N} {I}_{n}^{1} - α {\sum }_{n = 1}^{N} {I}_{n}^{2}$$

in which I_{C} is the corrected signal, I¹ₙ is the signal from the n^{th} of N first photodiodes, I²_{P} is the signal from the n^{th} of N second photodiodes, α is a predetermined weighting coefficient and N is a real positive integer satisfying N≤1.

The correction module may include a microprocessor or microcontroller.

The correction module may include a summing amplifier circuit configured to generate the corrected signal based on inputs received from the first and second photodetectors.

The first wavelength may be within the first range of wavelengths, the second wavelength may be within the first range of wavelengths, and the analytical test device may be configured to measure the absorbance of a sample.

The first wavelength may be outside the first range of wavelengths, the second wavelength may be outside the first range of wavelengths, and the analytical test device is configured to measure the fluorescence of a sample.

The sample receiving portion of the optical path may be configured to receive a lateral flow test strip. The sample receiving portion of the optical path may be configured to receive a cuvette. The sample receiving portion of the optical path may be configured to receive an assay well plate. The sample receiving portion of the optical path may be configured to receive the whole, a part, or a channel of a microfluidic device.

The analytical test device may also include a sample mounting stage moveable between a loading position and one or more measurement positions in which all or part of a mounted sample is disposed in the sample receiving portion of the optical path.

The analytical test device may also include driving means configured to move the sample mounting stage between the loading position and the measurement position or positions.

The analytical test device may also include a liquid transport path for transporting a liquid sample received proximate to an end of the liquid transport path through the sample receiving portion of the optical path.

A lateral flow test device may include the analytical test device and a lateral flow test strip arranged such that a test region is disposed within the sample receiving portion.

The lateral flow test strip may include labelling particles. An optical absorbance of the labelling particles may be greater within the second range of wavelength than within the third range of wavelengths.

According to a second aspect of the invention there is provided a method of analysing a sample using the analytical test device or the lateral flow test device. The method of analysing a sample includes receiving signals from the first and second photodetectors.

The method of analysing a sample also includes generating a corrected signal based on a weighted difference of the signals from the first and second photodetectors.

According to a third aspect of the invention there is provided a method of determining one or more weighting coefficients used for determining a corrected signal in the analytical test device or the method of analysing a sample. The method of determining one or more weighting coefficients includes modulating the light of the one or more light emitters according to a known time dependent signal, and iteratively modifying the one or more weighting coefficients to minimise or eliminate the time dependent signal from the corrected signal.

### BRIEF DESCRIPTION OF THE DRAWINGS

Certain embodiments of the present invention will now be described, by way of example, with reference to FIGS. 3 to 22 and 24 to 29 of the accompanying drawings in which:

FIG. 1 illustrates an emission side differentiated analytical test device;

FIG. 2 shows normalised spatial intensity profiles for light emitters used in the emission side differentiated analytical test shown in FIG. 1;

FIG. 3 illustrates a first receiving side differentiated analytical test device;

FIG. 4 is a projected view of a portion of a lateral flow test strip reader incorporating the first receiving side differentiated analytical test device;

FIG. 5 illustrates a lateral flow test strip;

FIG. 6 illustrates the fibrous structure of a lateral flow test strip;

FIG. 7 shows an absorbance spectrum of labelling particles used in a lateral flow test strip;

FIGS. 8 to 10 illustrate a process of correcting for background inhomogeneity of a lateral flow test strip;

FIG. 11 is a cross-sectional view of a bottom absorbing organic photodiode;

FIG. 12 is a cross-sectional view of a top absorbing organic photodiode;

FIG. 13 illustrates a second receiving side differentiated analytical test device;

FIGS. 14A and 14B show plan views of a first exemplary layout of photodetectors and filters for the second receiving side differentiated analytical test device;

FIG. 15 shows emission and absorbance characteristics corresponding to one example combination of a light emitter and filters suitable for measurements of labelling particles in the form of gold nanoparticles;

FIG. 16A shows a plan view of a second exemplary layout of photodetectors and filters for the second receiving side differentiated analytical test device;

FIG. 16B shows a plan view of a third exemplary layout of photodetectors and filters for the second receiving side differentiated analytical test device;

FIG. 17 is a cross-sectional view of an organic photodiode which includes an optical resonating micro-cavity;

FIG. 18 shows external quantum efficiency spectra corresponding to first, second and third examples of an organic photodiode shown in FIG. 17;

FIG. 19 is a circuit diagram of an amplifying adder circuit;

FIG. 20 illustrates a receiving side differentiated analytical test device based on transmitted light;

FIG. 21 illustrates a receiving side differentiated analytical test device based on reflected light;

FIG. 22 is a cross-sectional view of a lateral flow test device which incorporates a receiving side differentiated analytical test device;

FIG. 23 illustrates a test region of a lateral flow test strip received into an emission side differentiated analytical test device;

FIGS. 24A to 24D compare the stability of organic light-emitting diodes disposed on glass and plastic substrates;

FIG. 25 illustrates a method of determining one or more weighting coefficients for so use in a receiving side differentiated analytical test device;

FIG. 26 illustrates a fourth receiving side differentiated analytical test device;

FIG. 27 illustrates a fifth receiving side differentiated analytical test device

FIG. 28 illustrates a sixth receiving side differentiated analytical test device; and

FIG. 29 illustrates a seventh receiving side differentiated analytical test device.

### DETAILED DESCRIPTION OF CERTAIN EMBODIMENTS

If the number and complexity of optical components in a quantitative detector could be reduced, then the size and cost of the detector could be reduced. This would be of particular advantage for handheld or portable testing devices, and for single use home testing kits.

The minimum threshold for detecting an analyte may be improved if the signal to noise ratio of the measurement could be improved. Additionally, improvements in the signal to noise ratio may allow for an analyte concentration to be determined with improved resolution.

Emission Side Differentiated Analytical Test Device

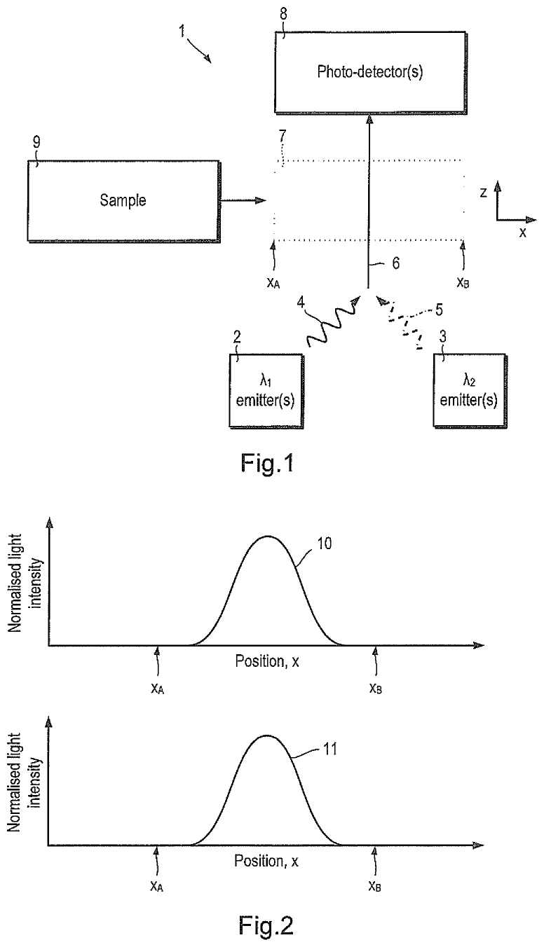

FIG. 1 shows an emission side differentiated analytical test device 1 which is useful for understanding the present invention. The emission side differentiated analytical test device 1 includes first and second light emitters 2, 3 which emit light 4, 5 onto an optical path 6 including a sample receiving portion 7. One photodetector 8 or several identical photodetectors 8 are disposed at the other end of the optical path 6 to receive light 4, 5 transmitted/reflected through/from the sample receiving portion 7. The sample receiving portion 7 is arranged to receive a sample 9 which is to be analysed for presence or absence of a target analyte.

Examples of emission side analytical test devices 1 have been described in detail in UK patent application no. 1616301.6, the contents of which are incorporated herein by reference. It shall aid understanding of the present invention to briefly discuss certain aspects of emission side analytical test devices 1.

Each first light emitter 2 is configured to emit light 4 within a range around a first wavelength λ₁, and each second light emitter 3 is configured to emit light 5 within a range around a second wavelength λ₂. The first light emitter(s) 2 may take the form of organic or inorganic light emitting diodes. Similarly, the second light emitter(s) 3 may take the form of organic or inorganic light emitting diodes. The analytical test device may include a plurality of first and second light emitters 2, 3 arranged in an array.

The one or more photodetector(s) 8 are sensitive across a broad wavelength range which includes at least the first and second wavelengths λ₁, λ₂. The photodetector(s) 8 may take the form of organic or inorganic photodiodes. The emission side analytical test device 1 may include a plurality of photodetectors 8 arranged in an array, however, each photodetector 8 in such an array has the same wavelength sensitivity.

The sample receiving portion 7 of the optical path 6 may be configured to receive a sample 9 in the form of a lateral flow test strip, a lateral flow test cartridge, a cuvette, assay (PCR) well/plate, a channel, or a microfluidic device.

The first and second wavelengths λ₁, λ₂ are chosen such that the absorbance of the first wavelength λ₁ by a target analyte is relatively stronger than the absorbance of the second wavelength λ₂ by the target analyte, or vice versa. The absorbance of the target analyte itself may not be determinative, for example, the absorbance of labelling particles of an immunoassay test which bind to the target analyte may instead form the basis for selecting the first and second wavelengths λ₁, λ₂.

The first light emitter(s) 2 and the second light emitter(s) 3 are illuminated alternately and corresponding first and second signals I₁, I₂ are detected by the photodetector(s) 8. The first and second signals I₁, I₂ are converted into absorbance values A₁ at the first and wavelength λ₁ and A₂ at the second wavelength λ₂. To calculate absorbance values A₁, A₂, a reference photodetector 8 signal may be obtained by, for example, alternately illuminating the first and second light emitters 2, 3 in the absence of a sample 9 or using a calibration sample which does not contain the target analyte.

A difference or weighted difference of the absorbance values A₁, A₂ is obtained, and effects of background inhomogeneity in the sample (other than the target analyte) may be reduced or removed in the difference. The difference takes the form of a change of absorbance (also referred to as a change in “optical density”). In this way the minimum quantity of a target analyte which is detectable by the analytical test device 1 may be improved. Reducing the effects of sample 9 background inhomogeneity is described hereinafter (FIGS. 5 to 10).

However, examples of emission side analytical test devices 1 described in UK patent application no. 1616301.6 require that the first light emitter(s) 2 and the second light emitter(s) 3 are illuminated alternately. This does not permit continuous and simultaneous monitoring at both first and second wavelengths λ₁, λ.

The emission side analytical test devices 1 described in UK patent application no. 1616301.6 require that the normalised spatial intensity profiles of light 4, 5 emitted by the respective first and second lighter emitters 2, 3 should be substantially equal across the sample receiving portion 7 of the optical path 6.

For example, referring to FIG. 2, if the sample receiving portion 7 spans a distance in a first direction x between first and second points x_{A}, x_{B}, and a distance in a second direction y between first and second points y_{A}, y_{B} (not shown), then the normalised spatial intensity 10 of light 4 emitted by the first emitters 2 should be substantially equal to the normalised spatial intensity 11 of light 5 emitted by the second emitters 3 across an incident surface of the sample receiving portion 7, i.e. for x_{A}≤x≤x_{B} and y_{A}≤y≤y_{B}.

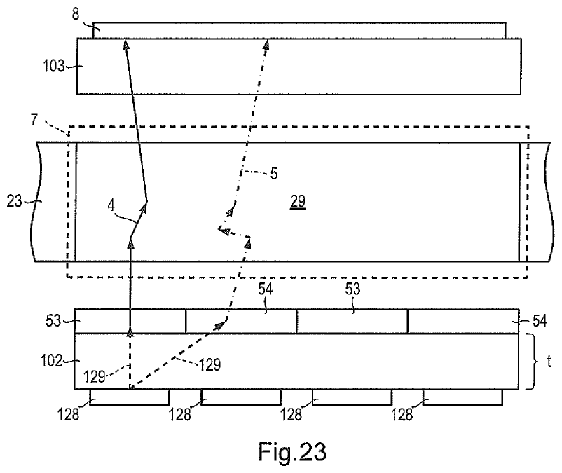

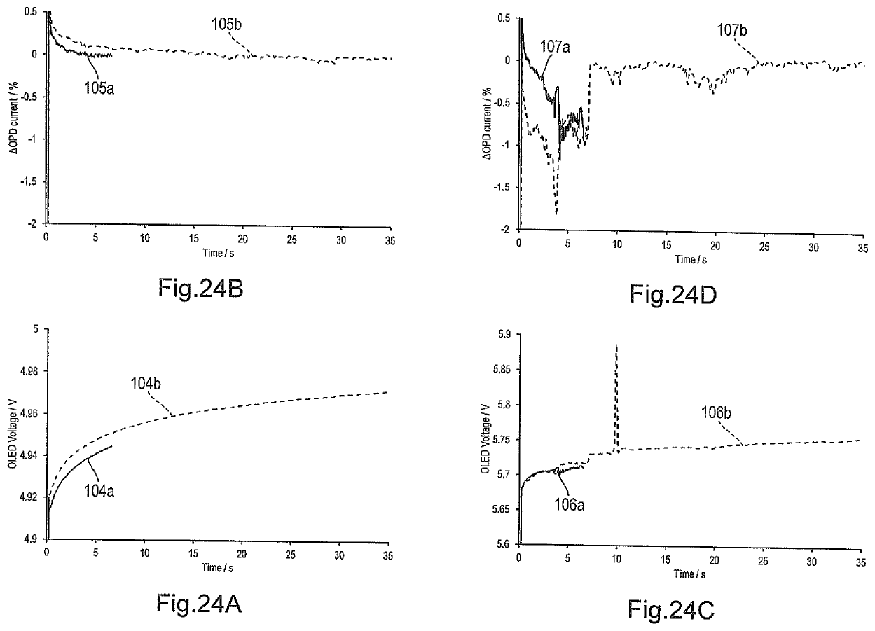

In practice, one example of a configuration which may obtain the required uniformity of light for emission side analytical test devices 1 is to use an array of first and second emitters 2, 3 in the form of bottom emitting organic light emitting diodes (OLEDs), coupled to respective filters disposed on the reverse side of the transparent substrate. The array of first and second emitters 2, 3 may be a checkerboard array, but in a preferred emission side analytical test device 1 the first and second emitters 2, 3 are interdigitated. In order to reduce or avoid cross-talk between closely spaced first and second emitters 2, 3, the transparent OLED substrate must be as thin as possible. Ideally, the substrate thickness is of the order of 100 μm or less, which makes glass substrates difficult to employ and prone to mechanical breakages. Plastic substrates have been found to result in poorer quality OLED devices having increased noise and reduced lifetime and reproducibility (FIGS. 23 and 24).

Amongst other advantages, the receiving side differentiated analytical test devices described in the present specification may avoid the hereinbefore described problems of emission side analytical test devices 1.

Receiving Side Differentiated Analytical Test Device

As described hereinbefore, an emission side differentiated analytical test device 1 uses two different types of light emitters 2, 3, illuminated alternately, to obtain a pair of signals for reducing or cancelling background inhomogeneity of a sample 9.

By contrast, receiving side differentiated analytical test devices described by the present specification use white, multi-coloured or broadband light emitters to illuminate a sample 9, and obtain the pair of signals for reducing or cancelling background inhomogeneity of a sample 9 using two types of photodetectors which have different wavelength sensitivities.

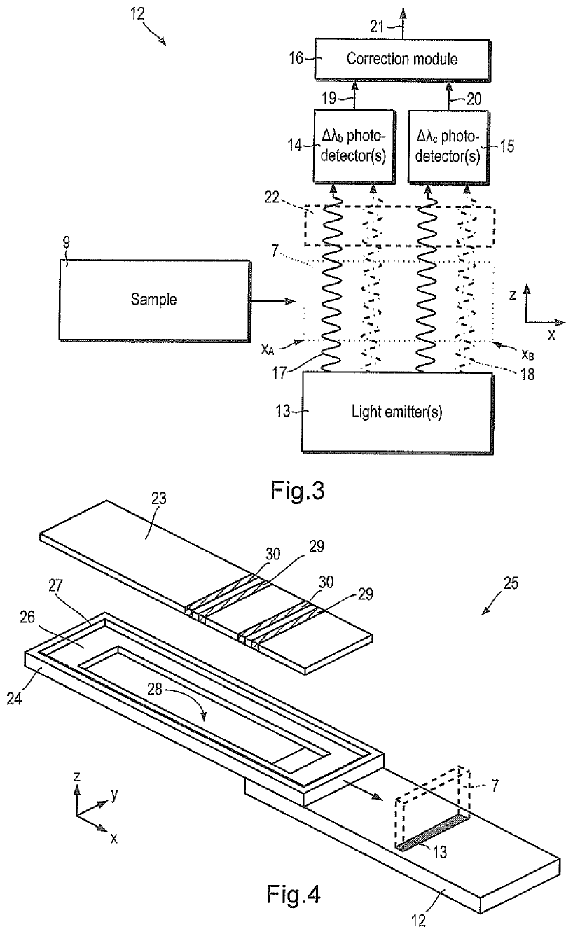

Referring to FIG. 3, a first analytical test device 12 is shown.

The first analytical test device 12 includes one or more light emitters 13, one or more first photodetectors 14, one or more second photodetectors 15 and a correction module 16.

The one or more light emitters 13 are each configured to emit light within a first range of wavelengths Δλₐ. The light emission within the first range of wavelengths Δλₐ need not be uniform, and in general will not be uniform. For example, the emission spectrum of a light emitter 13 may be a continuous broadband spectrum, or the emission spectrum of a light emitter 13 may include two or more peaks which overlap to a greater or lesser extent. The one or more light emitters 13 are white or multi-coloured light emitters, such as broadband or multiple-band emitters, rather than narrow band emitters. Herein, reference to a white or broadband light emitter 13 should be taken to refer also to a multi-coloured light emitter 13. Each first photodetector 14 is sensitive to a second range Δλ_{b} of wavelengths around the first wavelength λ₁. Each second photodetector 15 is sensitive to a third range Δλ_{c} of wavelengths around the second wavelength λ₂. The first and second wavelengths λ₁, λ₂ differ, and both lie within the first range Δλₐ. In other words, the first and second wavelengths λ₁, λ₂ satisfy the relationships min(Δλₐ)≤λ₁≤max(Δλₐ), min(ΔΔₐ)≤λ₂≤max(Δλₐ), and λ₁≠λ₂. At least one endpoint of the second range Δλ_{b} or the third range Δλ_{c} may lie outside of the first range Δλₐ. The second range Δλ_{b} and the third range Δλ_{c} do not significantly overlap. Preferably, any overlap of the second and third ranges Δλ_{b}, Δλ_{c} should be minimised. For example, the sensitivity of the first and/or second photodetectors 14, 15 may be less than 3 dB throughout any range of overlap between the second range Δλ_{b} and the third range Δλ_{c}.

The first analytical test device 12 is configured such that light 17, 18 from the light emitter(s) 13 reaches the first and second photodetectors 14, 15 via an optical path (not labelled in FIG. 3) comprising a sample receiving portion 7. The optical path is arranged such that, in response to a sample 9 being disposed in the sample receiving portion 7, the first and second photodetectors 14, 15 receive substantially equal quantities of light scattered from each part of the sample 9 within the sample receiving portion 7. In this way, each first photodetector 14 receives light 17 corresponding to the second wavelength range Δλ_{b} and light 18 corresponding to the third wavelength range Δλ_{c}. However, the first photodetector 14 generates a signal responsive to light 17 corresponding to the second wavelength range Δλ_{b} whereas the light 18 corresponding to the third wavelength range Δλ_{c} generates no, or minimal, response from the first photodetector 14. Similarly, the response of the second photodetector 15 is dominated by the incident light 18 corresponding to the third wavelength range 4A, even though the second photodetector 15 receives light 17, 18 corresponding to both the second and third wavelength ranges Δλ_{b}, Δλ_{c}.

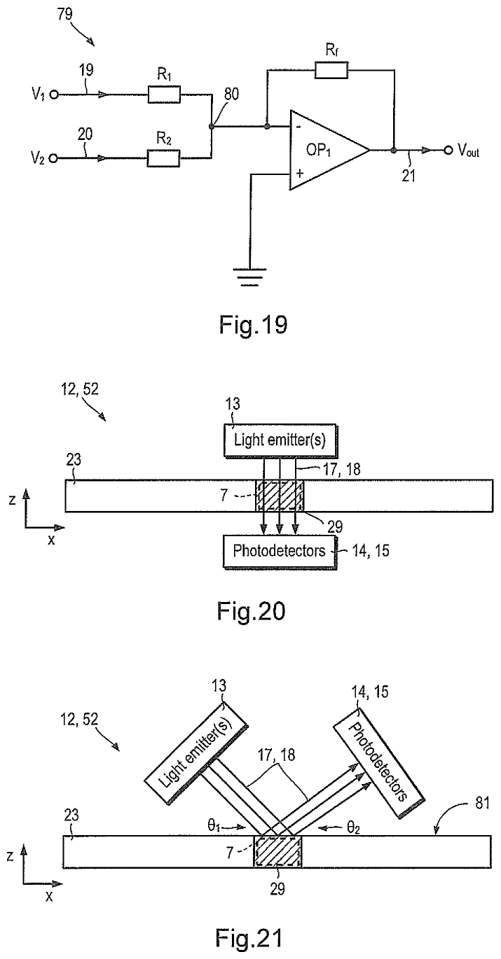

The correction module 16 receives first signals 19 from the first photodetectors 14 and corresponding to the incident intensity of light 17 corresponding to the second wavelength range Δλ_{b}. Similarly, the correction module 16 receives second signals 20 from the second photodetectors 15 corresponding to the incident intensity of light 18 corresponding to the third wavelength range Δλ_{c}. The correction module 16 generates a corrected signal 21 based on a weighted difference of the signals 19, 20 received from the first and second photodetectors 14, 15. The correction module 16 may include a microprocessor or microcontroller configured to generate the corrected signal 21 and, optionally, to convert the photodetector outputs into absorbance values. Alternatively, the correction module 16 may include an analog circuit configured to generate the corrected signal 21. For example, the correction module may include an amplifying adder circuit 79 (FIG. 19) configured to generate the corrected signal 21 based on first and second signals 19, 20 received from the first and second photodetectors 14, 15.

In some examples, the correction module 16 may include both an analog circuit configured to generate the corrected signal 21 and, in addition, a microprocessor or microcontroller configured to perform additional functions such as, for example, to convert photodetector outputs into absorbance values.

As explained further with reference to FIGS. 5 to 10, the effects of background inhomogeneity in the materials of the sample 9 may be reduced or removed in the corrected signal 21. In this way, the minimum detectable quantity of a target analyte may be improved. The resolution with which the concentration of a target analyte may be determined may also be improved.

Additionally, and in contrast to an emission side differentiated analytical test device 1, using the first analytical test device 12, the signals 19, 20 from the first and second photodetectors 14, 15 may be measured concurrently. This can allow the correction to be implemented using an analog circuit, which may improve the speed and/or accuracy of the correction. Additionally, a sample 9 may be continuously scanned through the sample receiving portion 7. With an emission side differentiated analytical test device 1, the sample motion must either stop to allow illumination of the same location with first and second light emitters 2, 3, or else measurements would relate to slightly different positions on the sample 9, with an associated decrease in the effectiveness of performing the background subtraction.

Furthermore, any fluctuations/spikes in light emitter 13 output will be correlated between the first and second photodetectors 14, 15, and hence removed by obtaining the difference. Any such real time fluctuations in light emitter 2, 3 output would not be corrected by an emission side differentiated analytical test device 1 as shown in FIG. 1.

Another advantage arises because the illumination of the sample 9 and measurement of the first and second signals 19, 20 may be obtained continuously, since there is no need to alternate between multiple types of light emitter. This permits use of increased integration times, which may further reduce the signal-to-noise ratio of measurements.

The light emitter(s) 13 may be any type of light emitter which can provide white light or light spanning a reasonably broad range of wavelengths such as, for example, a tungsten filament bulb, halogen bulb, fluorescent tube, inorganic light-emitting diode (LED) or organic light-emitting diode (OLED). A planar array of LEDs or OLEDs arranged close to the sample receiving portion 7 can provide good uniformity of illumination across the sample receiving portion 7. Preferably, the light emitter 13 takes the form of a single, uniform light emitter 13 such as, for example, a large area uniform white OLED. Preferably, the light emitter 13 is least co-extensive with the sample receiving portion 7.

In some examples, the uniformity of illuminating the first and second photodetectors 14, 15 may be enhanced by arranging a number of first photodetectors 14 and a number of second photodetectors 15 (or portions thereof) to form an alternating pattern. Each of the alternating photodetector 14, 15 (or portions thereof) is dimensioned to be smaller than an area of the sample receiving portion 7 projected onto the photodetectors 14, 15.

Optionally, in some examples the optical path of the first analytical test device 12 also includes an optical diffuser 22 arranged between the sample receiving portion 7 of the optical path and the first and second photodetectors 14, 15. In this way, uniformity of illuminating the first and second photodetectors 14, 15 may be enhanced or further enhanced.

The first and second photodetectors 14, 15 may take the form of inorganic or organic photodiodes. Each first photodetector 14 includes a first light sensitive material which is sensitive to the second wavelength range Δλ_{b} and each second photodetector 15 includes a second light sensitive material which is sensitive to the third wavelength range Δλ_{c}. A light sensitive material may be a blend or mixture of two or more materials. For example, a light sensitive material may be a blend of n-type and p-type organic conductors. In this way, the first and second photodetectors 14, 15 may be inherently or innately sensitive to different wavelength ranges through including different light sensitive materials.

The generation of the corrected signal 21 may be performed in a number of ways, depending primarily upon the number, type and geometry of the light emitter(s) 13, optical path and the first and second photodiodes 14, 15.

If the light emitter(s) 13 and photodetectors 14, 15 are relatively uniform, planar and parallel, such that the optical path and sample receiving portion 7 represent, effectively, a cuboidal gap between the light emitter(s) 13 and the photodetectors 14, 15, then the corrected signal 21 may be determined according to the general formula:

$${I}_{C} = {\sum }_{n = 1}^{N} {I}_{n}^{1} - α {\sum }_{n = 1}^{N} {I}_{n}^{2} \qquad ( 1 )$$

In which I_{C} is the corrected signal, I¹ₙ, is the signal from the n^{th} of N first photodetectors 14, I²ₙ, is the signal from the n^{th} of N second photodetectors, α is a predetermined weighting coefficient and N is a real positive integer satisfying N≥1. In the case of a single first photodetector 14 and a single second photodetector 15, Equation (1) simplifies to:

I_{C}=Iₙ¹−αIₙ² (2)

Alternatively, if the geometry of the light emitter(s) 13, optical path and the first and second photodetectors 14, 15 are more complex, different coefficients may be applied to the signals corresponding to each photodetector 14, 15 according to:

$${I}_{C} = {\sum }_{n = 1}^{N} {β}_{n} {I}_{n}^{1} - {\sum }_{n = 1}^{N} {γ}_{n} {I}_{n}^{2} \qquad ( 3 )$$

In which βₙ is a weighting factor corresponding to the n^{th} of N first photodetectors 14 and γₙ is a weighting factor corresponding to the n^{th} of N second photodetectors 15.

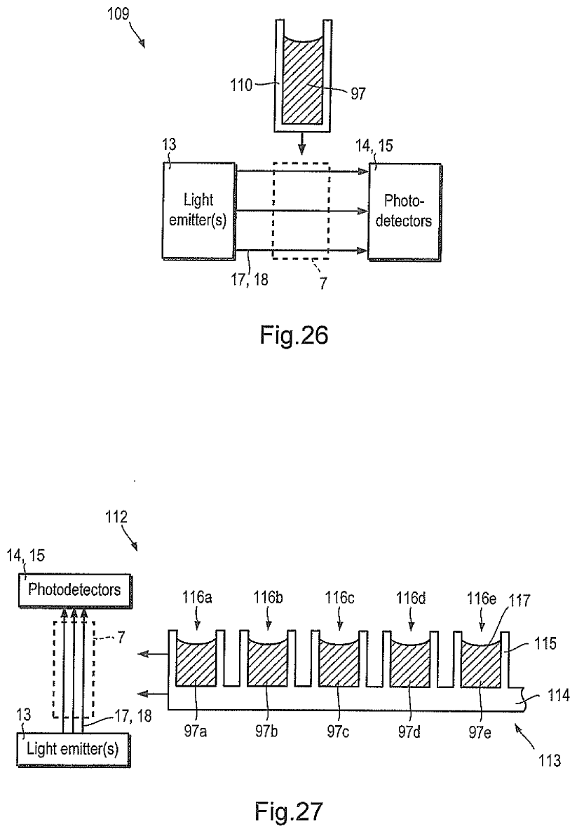

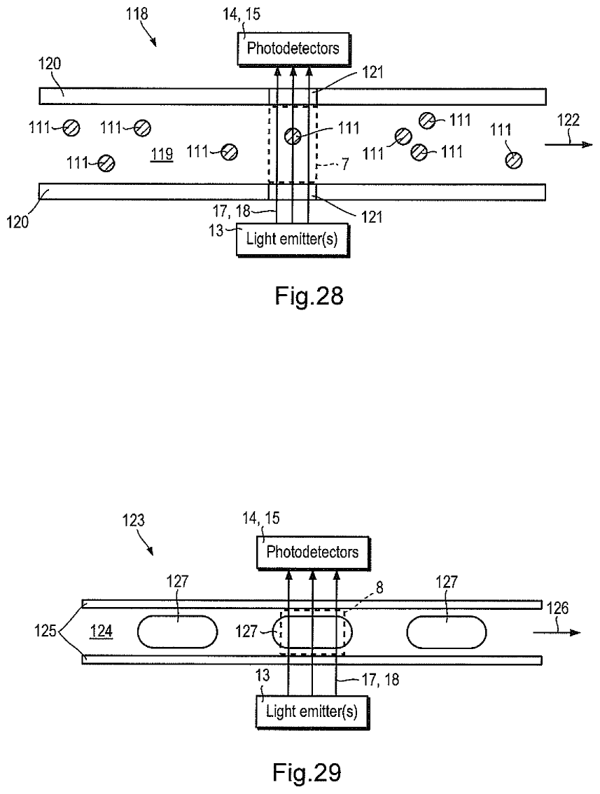

The sample 9 is not restricted to any specific form. For example, the sample receiving portion 7 of the optical path may be configured to receive a sample 9 in the form of a lateral flow test strip 23 (FIG. 4). Alternatively, the sample receiving portion 7 of the optical path may be configured to receive a sample 9 in the form of a cuvette (FIG. 26), an assay well plate (FIG. 27), a channel (FIG. 28), a portion of a microfluidic device (FIG. 29) and so forth.

The sample 9 may be simply placed within the sample receiving portion 7, for example resting on the light emitter(s) 13. Alternatively, the first analytical test device 12 may also include a sample mounting stage 24 (FIG. 4) which is moveable between a loading position and one or more measurement positions in which all or part of the mounted sample 9 is disposed in the sample receiving portion 7 of the optical path. In the loading position, the sample mounting stage 24 (FIG. 4) is configured to enable a sample to be readily placed and/or secured in, on or to the sample mounting stage 24 (FIG. 4). In some examples, driving means may be provided to move the sample mounting stage 24 (FIG. 4) between the loading position and the measurement position(s), for example a motor. Additionally or alternatively, the driving means may enable a sample 9 to be scanned through the sample receiving portion 7, for example, to scan along the length of a lateral flow test strip 23 (FIG. 4).

Lateral Flow Test Strip Reader

One example application of the first analytical test device 12 is as part of a lateral flow test strip reader 25.

Referring also to FIG. 4 a portion of a lateral flow test strip reader 25 incorporating the first analytical test device 12 is shown.

Lateral flow test strips 23 (also known as “lateral flow immunoassays”) are a variety of biological testing kit. Lateral flow test strips 23 may be used to test a liquid sample, such as saliva, blood or urine, for the presence of an analyte. Examples of lateral flow devices include home pregnancy tests, home ovulation tests, tests for other hormones, tests for specific pathogens and tests for specific drugs.

The lateral flow test strip reader 25 includes the first analytical test device 12 and a sample mounting stage 24. The sample mounting stage 24 includes a flat base 26 surrounded by a lip 27 projecting perpendicularly from the base 26. The flat base 26 is rectangular, and the base 26 and lip 27 are shaped and dimensioned to receive a lateral flow test strip 23 supported by the base 26 against gravity, such that the lip 27 substantially prevents the lateral flow test strip 23 from shifting when the sample mounting stage 24 is moved. The flat base 26 includes a substantially rectangular window 28. The window 28 has a long axis which is aligned with the long axis of the rectangular base 26. In this way, light 17, 18 from the light emitter(s) 13 may pass through the window 28 to illuminate the lateral flow test strip 23. Light 17, 18 transmitted through the lateral flow test strip 23 is detected by the first and second photodetectors 14, 15 (not shown in FIG. 4) as described hereinbefore.

The lateral flow test strip 23 includes one or more test regions 29. Optionally, the lateral flow test strip 23 may also include one or more control regions 30, for example one control region corresponding to each of the test regions 29. The sample mounting stage 24 is translated through the sample receiving portion 7 of the optical path to obtain a scan of the lateral flow test strip 23. In this way, the absorbance of each test region 29 and/or each control region 30 may be measured. Alternatively, if the positional registration of the lateral flow test strip 23, test region(s) 29 and optional control region(s) 30 are sufficiently precise, the sample mounting stage 24 may be moved directly to a pre-set position in which a test region 29 or control region 30 of interest is positioned within the sample receiving portion 7 of the optical path.

The sample mounting stage 24 may be manually movable. Preferably, the sample mounting stage 24 is coupled to driving means (not shown) which operate to scan the lateral flow test strip 23 through the sample receiving portion 7, or which operate to position the lateral flow test strip 23 at one or more pre-set positions. The driving means (not shown) may take the form of, for example, a motor, a hydraulic actuator or a pneumatic actuator.

The sample mounting stage 24 is merely one example of a sample mounting stage, and other configuration may be used which hold and/or secure a lateral flow test strip 23 using different means to the flat base 26 and lip 27.

Correction for Background Inhomogeneity of a Sample

Referring also to FIG. 5, a simplified lateral flow test strip 23 is illustrated.

The lateral flow test strip 23 extends longitudinally in a first direction x, transversely in a second direction y and has a thickness in a third direction z. A test region 29 is defined between positions B and B′ in the first direction x.

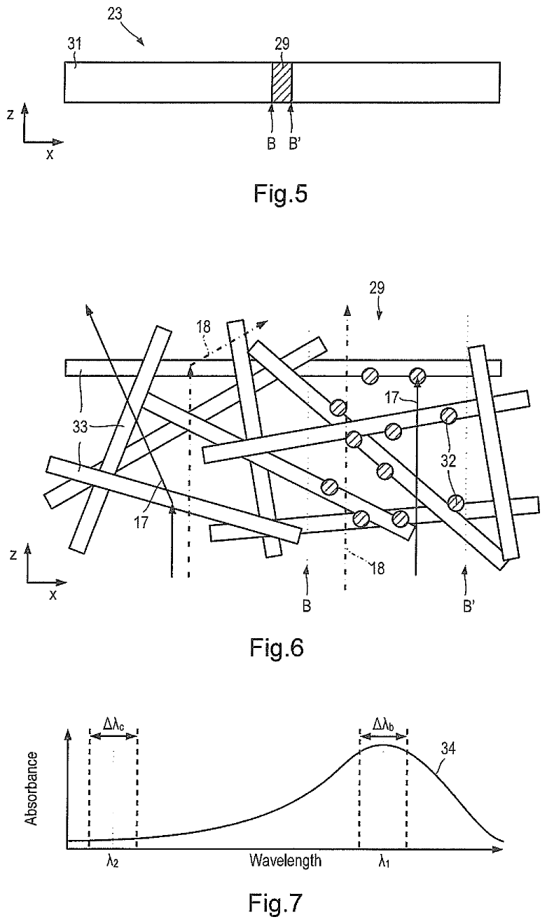

In a typical lateral flow test strip 23, a liquid sample is introduced at one end of a porous strip 31, and the liquid sample is then drawn along the lateral flow test strip 23 by capillary action (or “wicking”). The porous strip 31 is pre-treated with labelling particles 32 (FIG. 6) which are activated with a reagent which binds to the analyte to form a complex if the analyte is present in the liquid sample. The bound complexes, and also unreacted labelling particles 32 (FIG. 6) continue to propagate along the lateral flow test strip 23 before reaching the test region 29. The test region 29 is pre-treated with an immobilised binding reagent which binds complexes of analyte bound to labelling particles 32 (FIG. 6) and does not bind unreacted labelling particles 32 (FIG. 6). The labelling particles 32 (FIG. 6) have a distinctive colour, or otherwise absorb one or more ranges of ultraviolet, visible, infrared or near-infrared light. The development of a concentration of labelling particles 32 (FIG. 6) in the test region 29 may be measured and quantified using the first analytical test device 12, for example by measuring the absorbance arising from the labelling particles 32 (FIG. 6). The first analytical test device 12 may perform measurements on developed lateral flow test strips 23, i.e. the liquid sample has been left for a pre-set period to be drawn along the test strip 23.

Alternatively, the first analytical test device 12 may perform kinetic, i.e. dynamic time resolved measurements of the optical density of labelling particles 32 (FIG. 6). The first analytical test device 12 is especially well suited to dynamic time resolved measurements because the first and second photodetectors 14, 15 may be monitored concurrently and continuously.

Referring also to FIG. 6, the structure of a porous strip 31 of a lateral flow test strip 23 is illustrated.

The porous strip 31 is typically formed from a mat of fibres 33, for example nitrocellulose fibres. Within the test region 29, the immobilised binding reagent binds complexes of analyte and labelling particles 32.

The fibres 33 scatter and/or absorb light across a broad range of wavelengths in an approximately similar way. For example, the proportion of light 17 corresponding to the second wavelength range Δλ_{b} which is scattered by fibres 33 is approximately the same as the proportion of light 18 corresponding to the third wavelength range Δλ_{c}. However, the fibrous porous strip 31 is not uniform, and the density of fibres 33 may vary from point to point within the porous strip 31. As explained further hereinafter, such background variations of absorbance, which are due to the inhomogeneity of the porous strip 31, may limit the sensitivity of a measurement, i.e. the minimum detectable concentration of labelling particles 32.

Referring also to FIG. 7, an idealised absorbance spectrum 34 of labelling particles 32 used in a lateral flow test strip 23 is shown.

The first analytical test device 12 may compensate for such background variations of absorbance due to the inhomogeneity of the porous strip 31, provided that the first and second wavelengths λ₁, λ₂, and corresponding second and third wavelength ranges Δλ_{b}, Δλ_{c} are selected appropriately for the labelling particles 32 used for a lateral flow test strip 23. For example, an absorbance spectrum 34 of the labelling particles 32 may be obtained to determine how the absorbance of the labelling particles 32 varies with wavelength/frequency. The first wavelength λ₁ and corresponding second wavelength range Δλ_{b} are selected to be at, or close to, a peak absorbance of the labelling particles 32. The second wavelength λ₂ and corresponding third wavelength range Δλ_{c} are selected to lie at wavelengths which are away from a peak absorbance of the labelling particles 32. In other words, the first and second wavelengths λ₁, λ₂ and corresponding second and third wavelength ranges Δλ_{b}, Δλ_{c} are selected such that labelling particles 32 have relatively higher absorbance in the second wavelength range Δλ_{b} than in the third wavelength range Δλ_{c}. The ratio of absorbance between the first and second wavelengths λ₁, λ₂ may be a factor of, for example, at least 1.5, at least 2.0, up to and including 5.0, up to and including 10.0, up to an including 20.0, or more than 20.0.

The first and second wavelengths λ₁, λ₂ may lie in the range between 300 nm and 1500 nm inclusive. The first and second wavelengths λ₁, λ₂ may lie in the range between 400 nm and 800 nm inclusive.

Referring in particular to FIG. 6, light 17 corresponding to the second wavelength range Δλ_{b} is absorbed and/or scattered by the labelling particles 32, in addition to being absorbed and/or scattered by the fibres 33. By contrast, light 18 corresponding to the third wavelength range Δλ_{c} interacts with the labelling particles 32 only weakly or not at all.

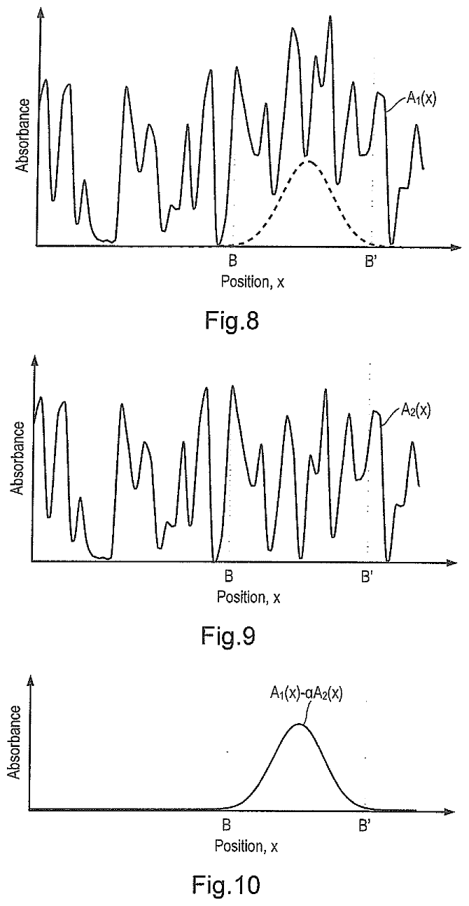

Referring also to FIGS. 8 to 10, generation of the corrected signal 21 is illustrated.

A lateral flow test strip 23 may be passed through the sample receiving portion 7 of the optical path of an example of the first analytical test device 12, for example using the lateral flow test strip reader 25, and the absorbance values A(x) measured as a function of position x along the porous strip 23 of the lateral flow test strip 23. The absorbance values A(x) are determined based on the difference in transmittance or reflectance when the sample 9, in this case the lateral flow test strip 23, occupies the sample receiving portion 7 and a reference condition, for example, the absence of a sample 9 or a calibration sample containing no labelling particles.

The first absorbance A₁(x) is measured by the first photodetector 14 and corresponds to the second wavelength range Δλ₆. Similarly, the second absorbance A₂(x) is measured by the second photodetector 15 and corresponds to the third wavelength range Δλ_{c}. The first and second absorbances A₁(x), A₂(x) have substantially equal contributions from scattering and/or absorption by the fibres 33 of the porous strip 31. The background level of absorbance varies with position x along the porous strip 31 due to the inhomogeneity of fibre 33 density. Absorbance signals resulting from the labelling particles 32 cannot be reliably detected unless they are at least larger than the background variance which results from inhomogeneity of the porous strip 31. This restricts the lower limit of labelling particle concentration which can be detected using a lateral flow test strip 23. The same background variance also limits the resolution of a quantitative measurement of labelling particle 32 concentration/optical density.

However, since the fibres 33 scatter light within the second and third wavelength ranges Δλ_{b}, Δλ_{c} in approximately the same way, the second absorbance values A₂(x) may be subtracted from the first absorbance values A₁(x) to reduce or remove the effect of the variations in background absorbance which result from the inhomogeneous distribution of fibres 33 in the porous strip. In practice, the difference is weighted with a weighing factor α, as in Equation (1), such that:

A_{C}(x)=A₁(x)−αA₂(x) (4)

In which A_{C}(x) correspond to the corrected signal 21 in the form of corrected absorbance values. The values A_{C}(x) correspond to a change in absorbance attributable to the labelling particles 32. Alternatively, as described in relation to Equations (1) to (3), the correction may be performed directly on the first and second signals 19, 20 output by the first and second photodetectors 14, 15, and the correction module 16 may subsequently convert the corrected signal I_{C}(x) into a change in absorbance A_{C}(x) attributable to the labelling particles.

Although in practice some amount of background variance in absorbance will remain when the difference A₁(x)−αA₂(x) is obtained, the relative size of the signal which is specific to the labelling particles 32 may be increased, in some cases substantially, with respect to background variations. In this way, the lower limit of labelling particle 32 concentrations which can be detected may be reduced. Similarly, the resolution of a quantitative measurement of labelling particle 32 concentration/optical density may be increased.

Organic Photodetectors

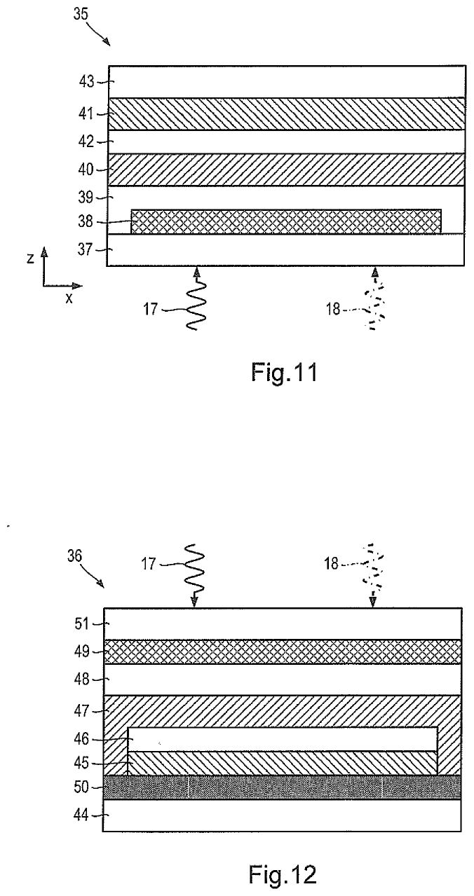

Referring also to FIGS. 11 and 12, layer structures of exemplary organic photodetectors (OPDs) 35, 36 are shown.

Referring in particular to FIG. 11, the first analytical test device 12 may include first and second photodetectors 14, 15 in the form of bottom absorbing OPDs 35.

An exemplary bottom absorbing OPD 35 includes a layer structure which includes, arranged in a thickness direction z, a transparent substrate 37, a transparent anode layer 38 including one or more anode electrodes, a hole-transporting layer 39, an OPD active layer 40 which is sensitive to light, and a reflecting cathode layer 41 including one or more cathode electrodes. The OPD active layer 40 takes the form of a blend of n-type and p-type organic semiconductors. Optionally, depending on the material or materials used for the OPD active layer 40, the bottom absorbing OPD 35 may also include an electron-transporting layer 42 (sometimes also referred to as a “hole-blocking” layer) disposed between the OPD active layer 40 and the reflecting cathode layer 41. An encapsulation layer 43 typically overlies the reflecting cathode 41 to protect the bottom absorbing OPD 35 against ingress of moisture which may be detrimental to some or all of the materials forming the bottom absorbing OPD 35.

First and second photodetectors 14, 15 taking the form of bottom absorbing OPDs 35 may be configured for sensitivity to the respective second and third wavelength ranges Δλ_{b}, Δλ_{c} by selecting different materials for the OPD active layers 40 of the first and second photodetectors 14, 15.

Referring in particular to FIG. 12, the first analytical test device 12 may include first and second photodetectors 14, 15 in the form of top absorbing OPDs 36.

An exemplary top absorbing OPD 36 includes a layer structure which includes, arranged in a thickness direction z, a substrate 44, a transparent cathode layer 45 including one or more cathode electrodes, an electron modifier layer 46 (sometimes also referred to as an “electron extraction layer”), an OPD active layer 47 which is sensitive to light, a hole transport layer 48, and a transparent or semi-transparent anode layer 49 including one or more anode electrodes. The electron modifier layer 47 is provided in order to modify the work function of the cathode layer 45, for example indium tin oxide (ITO), in order to make the work function of the cathode layer 45 and electron modifier layer 46 in combination shallower. The OPD active layer 47 takes the form of a blend of n-type and p-type organic semiconductors. Optionally, a reflecting layer 50 may be disposed between the cathode layer 45 and the substrate 44. An encapsulation layer 51 typically overlies the anode layer 49 to protect the top absorbing OPD 36 against the ingress of moisture which may be detrimental to some of all of the materials forming the top absorbing OPD 36. The substrate 44 may be transparent or semi-transparent, although this is not essential for the top absorbing OPD 36.

First and second photodetectors 14, 15 taking the form of top absorbing OPDs 36 may be configured for sensitivity to the respective second and third wavelength ranges Δλ_{b}, Δλ_{c} by selecting different materials for the OPD active layers 47 of the first and second photodetectors 14, 15.

Receiving Side Differentiated Analytical Test Device Using Filters

The first and second photodetectors 14, 15 of the first analytical test device 12 are sensitive to the respective second and third wavelength ranges Δλ_{b}, Δλ_{c} because the first and second photodetectors 14, 15 include different light sensitive materials. However, use of different light sensitive materials for the first and second photodetectors 14, 15 is not essential.

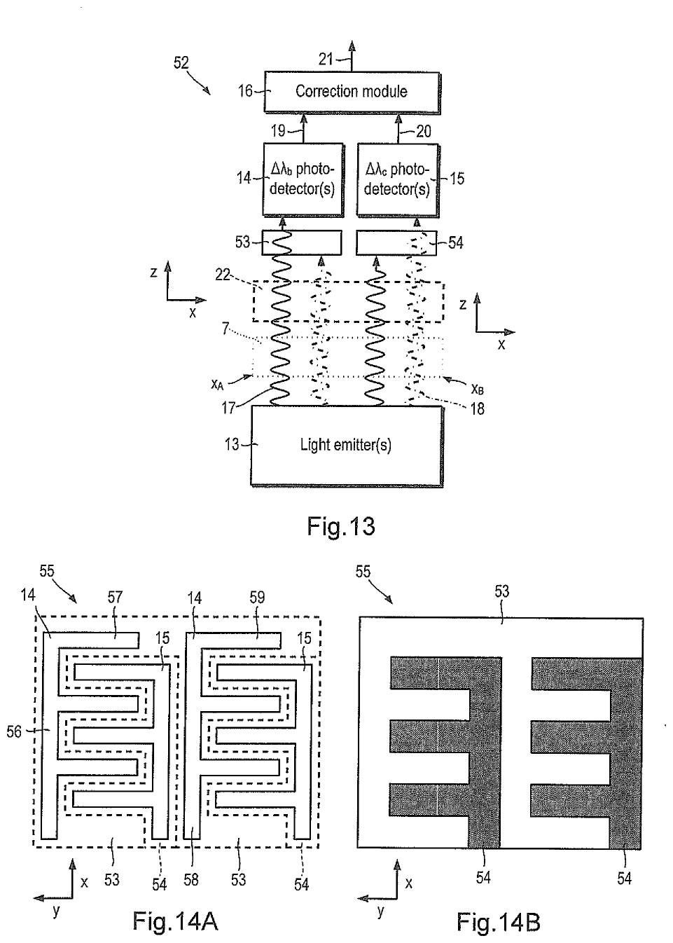

Referring also to FIG. 13, a second analytical test device 52 is shown.

The second analytical test device 52 is the same as the first analytical test device 12, except that the first and second photodetectors 14, 15 include the same light sensitive materials. For example, when the first and second photodetectors 14, 15 take the form of bottom or top absorbing OPDs 35, 36, then the OPDs 35, 36 may include identical OPD active layers 40, 47.

In order to provide the correct wavelength sensitivities, the second analytical test device 52 includes first filters 53 corresponding to or incorporated within each first photodetector 14 and second filters 54 corresponding to or incorporated within each second photodetector 15. Each first filter 53 is arranged to filter light 17, 18 arriving from the sample receiving portion 7 via the optical path before it arrives to the light sensitive material of the corresponding first photodetector 14. Each first filter 53 is configured to transmit the light 17 corresponding to the second wavelength range Δλ_{b} and to attenuate the light 18 corresponding to the third wavelength range Δλ_{c}. Similarly, each second filter 54 is arranged to filter light 17, 18 arriving from the sample receiving portion 7 via the optical path before it arrives to the light sensitive material of the corresponding second photodetector 15. Each second filter 54 is configured to transmit the light 17 corresponding to the third wavelength range Δλ₀ and to attenuate the light 18 corresponding to the second wavelength range Δλ_{b}.

Each first filter 53 may be integrated into the respective first photodetector 14 and each second filter 54 may be integrated into the respective second photodetector 15. For example, each first photodetector may include a light sensitive material and a first filter 53, and each second photodetector may include the light sensitive material and a second filter 54. Alternatively, the filters 53, 54 may be provided as a separate layer which overlies the first and second photodetectors 14, 15.

When the first and second photodetectors 14, 15 take the form of bottom absorbing OPDs 35, the first and second filters 53, 54 may be disposed on the opposite side of the transparent substrate 37 to the anode layer 38, for example, by printing coloured inks.

When the first and second photodetectors 14, 15 take the form of top absorbing OPDs 36, the first and second filters 53, 54 may be disposed over the encapsulation layer 51, for example, by printing colour inks. Alternatively, the first and second filters 53, 54 may be provided over the anode layer 49, and the encapsulation layer 51 deposited over the first and second filters 53, 54. In a further alternative, the encapsulation layer 51 may itself integrally incorporate the first and second filters 53, 54, for example, the encapsulation layer 51 may take the form of a single piece film of transparent polymer which has been dyed or otherwise treated such that different regions are coloured differently.

Referring also to FIGS. 14A and 14B, a first exemplary layout 55 of the photodetectors 14, 15 and filters 53, 54 of the second analytical test device 52 is shown.

Referring in particular to FIG. 14A, each first photodetector 14 includes a spine 56 extending in a first direction x and a number of branches 57 extending from the spine 56 in a second direction y. Similarly, each second photodetector 15 includes a spine 58 extending in a first direction x and a number of branches 59 extending from the spine 58 in a second direction y and in the opposite sense to the branches 57 of the first photodetector 14. Each pair of first and second photodetectors 14, 15 is arranged such that the corresponding branches 57, 59 are interdigitated.

Referring now in particular to FIG. 14B, the corresponding first and second filters 53, 54 are arranged in a corresponding interdigitated arrangement.

In this way, differences in the amount of light 17, 18 incident on the first and second photodetectors 14, 15 may be reduced. The uniformity of illuminating the first and second photodetectors 14, 15 may be further improved when the optional diffuser 22 is included in the optical path between the sample receiving portion 7 and the photodetectors 14, 15.

Interdigitated branches 57, 59 need not be used, and in an alternative example, a number of first photodetectors 14 may be elongated in the first direction x and a number of second photodetectors 15 may be elongated in the first direction x, and the first and second photodetectors 14, 15 may be interdigitated in the second direction y.

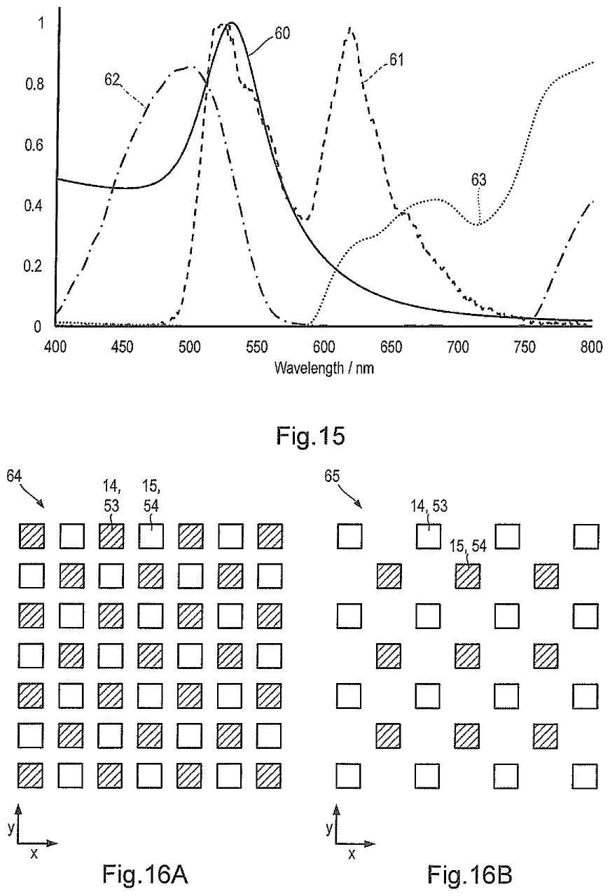

Referring also to FIG. 15, emission and absorbance characteristics corresponding to one example combination of light emitter 13 and filters 53, 54 for measurements of labelling particles 32 are shown.

The normalised absorbance 60 of the labelling particles 32 (solid line in FIG. 15) corresponds to labelling particles 32 in the form of 40 nm gold nanoparticles. Such gold nanoparticles may be used as labelling particles 32 in lateral flow test strip 23 systems. The normalised emission spectrum 61 of an OLED (dashed line in FIG. 15) is also shown for reference. It may be observed that the gold nanoparticle absorbance spectrum 60 shows a peak absorbance around green wavelengths and relatively weak absorbance around red wavelengths. In this example, the second wavelength range Δλ_{b} may be selected to correspond to green wavelengths and the third wavelength range Δλ_{c} may be selected to correspond to red wavelengths. FIG. 15 shows a normalised absorbance spectrum 62 (chained line in FIG. 15) of a first filter 53 in the form of a green filter which transmits a second wavelength range Δλ_{b} from about 400 nm to about 600 nm. FIG. 15 also shows a normalised absorbance spectrum 63 (dotted line in FIG. 15) of a second filter 54 in the form of a red filter which transmits a third wavelength range Δλ₆ from about 600 nm into the near infrared (NIR).

In this way, the first photodetector(s) 14 will detect a strong change in absorbance when gold nanoparticles are present in the sample receiving portion 7, whereas the response of the second photodetector(s) 15 to the gold nanoparticles will be small or negligible. By contrast, the fibres 33 making up the porous strip 31 of a lateral flow test strip 23 are typically white or substantially white, so that the responses of the first and second photodetectors 14, 15 to the fibres 33 and any inhomogeneity thereof will be correlated. Thus, the effects of background inhomogeneity of the fibres 33 may be reduced or removed by obtaining a difference as described hereinbefore (Equations (1) to (4)).

Referring also to FIG. 16A, a second exemplary layout 64 of the photodetectors 14, 15 and filters 53, 54 of the second analytical test device 52 is shown.

In the second layout 64, a number of first photodetectors 14 and a number of second photodetectors 15 are arranged in an alternating grid. The corresponding first and second filters 53, 54 are also arranged in an alternating grid.

The first photodetectors 14 and corresponding first filters 53 are disposed in a first lattice and that the second photodetectors 15 and corresponding second filters 54 are disposed in a second lattice. The first and second lattices are identical except that the second lattice is displaced with respect to the first lattice, such that the first and second lattices are interpenetrating. In the example shown in FIG. 16A, the first and second lattices may be viewed as either oblique lattices having a unit cell including a single filter 53, 54, or as square lattices having a unit cell with a motif including a pair of filters 53, 54.

Referring also to FIG. 16B, a third exemplary layout 65 of the photodetectors 14, 15 and filters 53, 54 of the second analytical test device 52 is shown.

The third layout 65 is the same as the second layout 64, except for the form of the first and second lattices. In this case, the first and second lattices are each a square lattice having a unit cell including a single filter 53, 54.

Any other suitable pattern of interpenetrating 2D lattices may be used to arrange the photodetectors 14, 15 and filters 53, 54 of the second analytical test device 52.

Although the interdigitated arrangement shown in FIGS. 14A and 14B and the interpenetrating lattice arrangements shown in FIGS. 16A and 16B have been described in relation to the second analytical test device 52, the same or similar arrangements of the first and second photodetectors 14, 15 may be employed in the first analytical test device 12 in order to enhance the uniformity of illuminating the first and second photodetectors 14, 15.

Receiving Side Differentiated Analytical Test Device Using Resonating Cavities

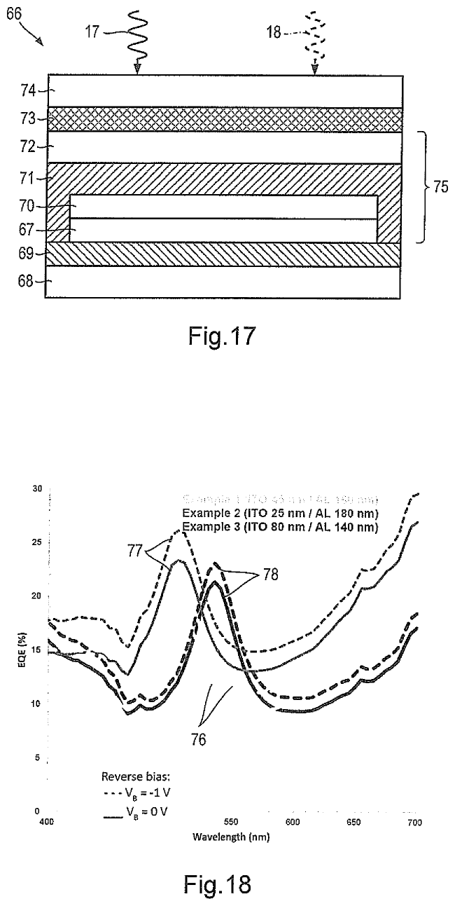

Referring also to FIG. 17, a layer structure of a modified top absorbing OPD 66 is shown.

A third analytical test device (not shown) is the same as the second analytical test device 52, except that instead of first and second filters 53, 54, the third analytical test device uses modified top absorbing OPDs 66 which include resonating microcavities 75 which may be tuned to enhance absorbance at desired wavelengths.

The modified top absorbing OPD 66 includes a substrate 68 having a reflective cathode 69 disposed thereon. A transparent conductive oxide layer 67 is disposed on the reflective cathode 69 and an electron transporting layer 70 is disposed on the transparent conductive oxide layer 67. The transparent conductive oxide layer 67 may take the form of, for example, indium tin oxide (ITO). The transparent conductive oxide layer 67 and the electron transporting layer 70 together comprise a bilayer stack. An OPD active layer 71 is disposed on the bilayer stack. The OPD active layer 71 takes the form of a blend of n-type and p-type organic semiconductors. A hole-transport layer 72 is disposed between the OPD active layer 71 and a semi-transparent anode layer 73, and is in electrical contact with both. An encapsulation layer 74 is provided to cover the anode layer 73 and enclose the modified top absorbing OPD 66 to prevent or slow the ingress of moisture which may have a detrimental effect on some or all of the materials of the modified top absorbing OPD 66. The microcavity 75 is formed between the semi-transparent anode layer 73 and the reflective cathode 69.

The modified top absorbing OPD 66 exhibits a favourable photoresponse which enables effective and efficient colour discrimination, since particularly narrow full width at half maximum (FWHM) and high external quantum efficiency (EQE) values may be simultaneously attained, so that wavelength sensitivity may be improved without the use of optical filters. Accordingly, the third analytical test device does not include the first and second filters 53, 54.

It has been surprisingly found that the resonance wavelength of the microcavity 75 may not only be altered by varying the OPD active layer 71 thickness, but also by the variation of the total thickness of the transparent conductive oxide layer 67 and the OPD active layer 71 which includes a blend of an n-type organic semiconductor and a p-type organic semiconductor. In this way, it is possible to set the OPD active layer 71 thickness to an optimized value in terms of EQE efficiency, processability and so forth, and to then tune the microcavity 75 resonance wavelength by adjusting the conductive oxide layer 67 thickness without substantially affecting the performance of the modified top absorbing OPD 66.

Preferably, the n-type organic semiconductor and the p-type organic semiconductor which are blended to form the OPD active layer 71 are selected so that the OPD active layer 71 exhibits a transmittance T of at least 50%, at a target wavelength λₘₐₓ, which is the wavelength of the maximum of the external quantum efficiency (EQE) spectrum of the modified top absorbing OPD 66 at a desired range, measured according to ASTM E1021. For example, for the first photodetector 14, the wavelength λₘₐₓ should correspond to the first wavelength λ₁, or at least lie within the second wavelength range Δλ_{b} around the first wavelength λ₁. The wavelength λₘₐₓ may also be tuned by varying the thickness of the OPD active layer 71. The thickness of the transparent conductive oxide layer 67 is then adjusted in order to tune the resonance wavelength of the microcavity 75 to the desired value λₘₐₓ.

The modified top absorbing OPD 66 may be fabricated using one or more deposition techniques such as, for example, photolithographic methods, sputtering techniques, thermal deposition, vacuum deposition, laser deposition, screen printing, printing, imprinting, spin coating, dipping, ink-jetting, roll coating, flow coating, drop casting, spray coating, and/or roll printing.

In this way, instead of using filters 53, 54, sensitivity of the first and second photodetectors 14, 15 to the respective second or third wavelength ranges Δλ_{b}, Δλ_{c} may be provided by using modified top absorbing OPDs 66 including resonant cavities 75 having appropriately tuned resonance wavelengths. For example, each first photodetector 14 may include a light sensitive material in the form of OPD active layer 71, and a first resonant cavity 75 configured to couple to light 17 corresponding to the second wavelength range Δλ_{b}. Similarly, each second photodetector 15 comprises a light sensitive material in the form of OPD active layer, and a second resonant cavity 75 configured to couple to light 18 corresponding to the third wavelength range Δλ_{c}.

Examples of Modified Top Absorbing Photodetectors

First, second and third examples of the modified top absorbing photodetector 66 were manufactured and evaluated, using silver to form the semi-transparent anode layer 73 and the reflective cathode 69. The OPD active layers 71 were formed from a blend of a PCBM-type fullerene derivative, specifically phenyl-C61-butyric acid methyl ester (C60PCBM), and a p-type organic semiconductor according to structural formula (A):

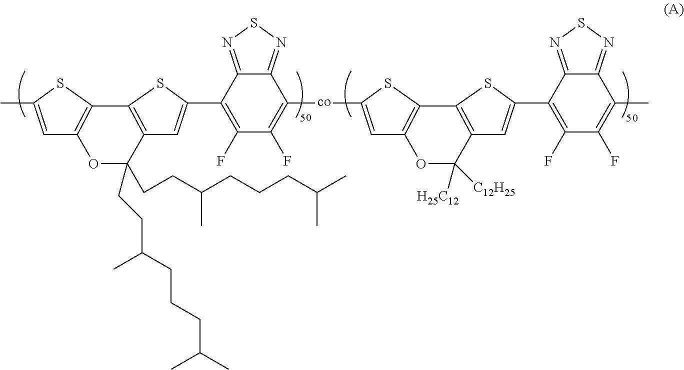

Both C60PCBM and compound (A) are characterized by a low absorbance around an example target wavelength of 550 nm (green) and exhibit absorption maxima at about 430 nm (C60PCBM and compound (A)), 720 nm (compound (A)) and 800 nm (compound (A)). It is ensured that the transmittance T of the active layer comprising the blend of C60PCBM and compound (A) at the target wavelength 550 nm (λₘₐₓ) is at least 50% at the thicknesses given in the examples described hereinafter.

### Example 1

As the transparent conductive oxide layer 67, an ITO layer having a thickness of 45 nm was deposited onto the reflective cathode 69 formed from silver, whereas the OPD active layer 71 thickness was 160 nm, which resulted in a total thickness of active and conductive oxide layers of 205 nm.

### Example 2

An organic photodetector was prepared in accordance with Example 1, with the exception that the ITO layer had a thickness of 25 and the active layer thickness was 180 nm, such that the total thickness of active and conductive oxide layers remained 205 nm.

### Example 3

A further organic photodetector was prepared in accordance with Example 1, with the exception that the ITO layer had a thickness of 80 nm and the active layer thickness was 140 nm, resulting in a total thickness of active and conductive oxide layers of 220 nm.

The external quantum efficiency of each of the organic photodetectors of Examples 1 to 3 was measured in a wavelength range of about 400 to 700 nm using a calibrated incident photon to charge carrier efficiency (IPCE) measurement system. The FWHM is calculated as width of a wavelength corresponding to a half of maximum EQE using a Gaussian fitting curve of the central EQE peak.

Referring also to FIG. 18, the external quantum efficiency (EQE) spectra 76, 77, 78 corresponding to the OPDs of Examples 1 to 3 are shown. The dashed curves denote the EQE response at a reverse bias voltage V_{B} of −1 V, and the solid curves denote the EQE response at V_{B}=0V.

It may be observed that the EQE spectrum 77 (dark grey lines in FIG. 18) of the OPD of Example 2 exhibits an EQE peak centred around 510 nm with a FWHM of about 40 nm and an external quantum efficiency of about 26% at V_{B}=−1 V and about 23% at V_{B}=0 V.

Similarly, it may be observed that the EQE spectrum 76 (light grey lines in FIG. 18) of the OPD of Example 1 also exhibits a peak centred around 510 nm with a FWHM of about 40 nm, with a comparatively lower external quantum efficiency (about 20% at V_{B}=−1 V and about 18% at V_{B}=0 V). It may be observed that the resonance wavelength does not substantially shift upon increasing the OPD active layer 71 thickness to 180 nm, due to the decrease in transparent conductive layer 67 thickness, such that the overall thickness is the same as Example 1.

By way of contrast, it may be observed that the EQE spectrum 78 (black lines in FIG. 18) of the OPD of Example 3 demonstrates that the increase of the total thickness of the OPD active layer 71 and conductive transparent oxide layer 67 to 220 nm shifts the EQE maximum to a longer wavelength, around 535 nm, which demonstrates that the resonance wavelength may be tuned to a desired value by adjusting the transparent conductive oxide layer 67 thickness without changing the OPD active layer thickness 71, and hence without a substantial impact on the FWHM and external quantum efficiency when compared to Example 1 (FWHM of about 40 nm, EQE about 23% at V_{B}=−1 V and about 21% at V_{B}=0 V).

Circuit for Generating the Corrected Signal

FIG. 19 is a circuit diagram of an example of an amplifying adder circuit 79 which may be included in the correction module 16.

The circuit 79 includes a first input terminal V₁ for receiving first signals 19 from a first photodetector 14 and a second input terminal V₂ for receiving second signals 20 from a second photodetector 15. The first input terminal V₁ is coupled to the inverting input of an operational amplifier OP₁ via a first resistance R₁. Similarly, the second input terminal V₂ is coupled to the inverting input of the operational amplifier OP₁ via a second resistance R₂. One terminal each of the first and second resistances R₁, R₂ connects to the inverting input at a node 80. The non-inverting input of the amplifier OP₁ is connected to ground. The circuit 79 include a feedback network in the form of a feedback resistance R_{f} connected between the inverting input and the output Vₒᵤₜ of the amplifier OP₁. The amplifier output Vₒᵤₜ provides the corrected signal 21. The amplifier output Vₒᵤₜ is determined by the values of the first, second and feedback resistances R₁, R₂, R_{f} according to:

$$- {V}_{out} = {V}_{1} ( \frac{{R}_{f}}{{R}_{1}} ) + {V}_{2} ( \frac{{R}_{f}}{{R}_{2}} ) \qquad ( 5 )$$

In this way, the amplifying adder circuit 79 may be employed to implement Equation (2). Moreover, by including further voltage inputs V₃, . . . , V coupled to the node 80 by corresponding resistances, Equations (1) or (3) may equally be implemented in an amplifier circuit.

In this way, the first, second and/or third receiving side differentiated analytical test devices 12, 52 may generate a corrected signal 21 in real time and without the need to separately amplify and convert the input signals 19, 20 to digital data before the correction is performed. This may reduce the amount of uncorrelated noise acquired by the signals 19, 20 prior to obtaining the difference, and as a result the quality of the corrected signal may be improved compared to the emission side analytical test devices 1 described in UK patent application no. 1616301.6.

Measurement Geometries

The first, second and/or third analytical test devices 12, 52 may be configured to use a range of light emitter 13 and photodetector 14, 15 geometries.

Referring also to FIG. 20, a configuration is shown in which the optical path is configured such that the first and second photodetectors 14, 15 receive light transmitted through the sample receiving portion 7.

For measurements in transmission, the light emitter(s) 13 and photodetectors may simply be spaced apart by a gap which corresponds to the optical path. The sample receiving portion 7 of the optical path then corresponds to the part of the gap which is occupied by a sample 9 when the sample 9 is received into the analytical testing device 12, 52.

For example, if a sample 9 in the form of a lateral flow test strip 23 is used, the lateral flow test strip 23 may be arranged with a testing region 29 positioned between the light emitter(s) 13 and photodetectors 14, 15. The sample receiving portion 7 of the path corresponds to the thickness of the lateral flow test strip 23 which intersects the optical path.

Additional optical components may be included in the optical path. For example, the light from the light emitter(s) 13 into the optical path and/or the light from the optical path to the photodetectors 14, 15 may be restricted by slits or other apertures. Optionally, a diffuser 22 may also be included in the optical path between the sample receiving portion 7 and the photodetectors 14, 15.

However, the first, second and third analytical devices 12, 52 described herein are equally applicable for measurements in reflection.

Referring also to FIG. 21 a configuration is shown in which the optical path is configured such that the first and second photodetectors 14, 15 receive light reflected from the sample receiving portion 7.

For example, when the analytical testing device 12, 52 is arranged to receive samples 9 in the form of lateral flow test strips 23, the light emitter(s) 13 may be arranged to illuminate a region of interest of a lateral flow test strip 23 received into the analytical test device 12, 52 at first angle θ₁, and the photodetectors 14, 15 may be arranged to receive light reflected from the lateral flow test strip 23. Light reflected from the porous strip 31 of a lateral test strip 23 will, in general, be scattered into a wide range of different angles due to the largely random orientations of the fibres 33. Consequently, the portion of the optical path between the sample receiving portion 7 and the photodetector(s) 14, 15 may be oriented at a second angle θ₂, which does not need to be equal to the first angle θ₁. In some examples, the first and second angles θ₁, θ₂ may be equal. In some examples, the light emitter(s) 13 and photodetector(s) 14, 15 may be arranged in a confocal configuration. Light reflected from the sample 9 may originate from a surface 81 of the sample 9, or from a depth within the sample 9.

Additional optical components may be included in the optical path. For example, the light from the light emitter(s) 13 into the optical path and/or the light from the optical path to the photodetectors 14, 15 may be restricted by slits or other apertures. Optionally, a diffuser 22 may also be included in the optical path between the sample receiving portion 7 and the photodetectors 14, 15.

Lateral Flow Device Having Integral Analytical Test Device

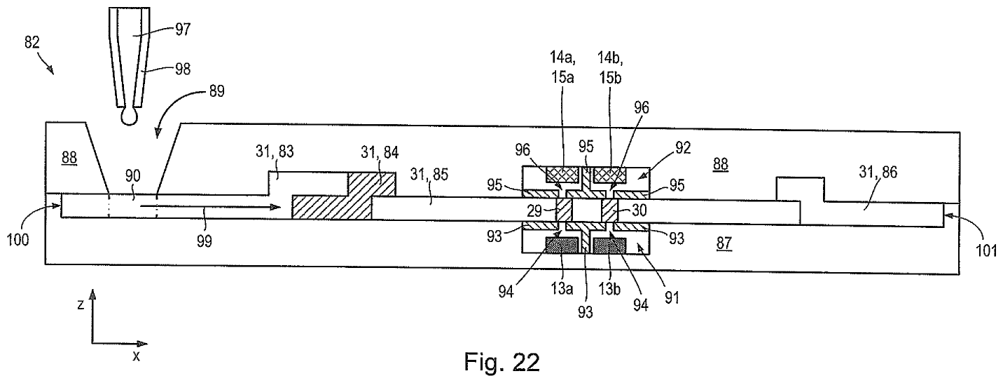

Referring also to FIG. 22, a lateral flow device 82 is shown which incorporates an integrated example of the first, second or third analytical test device 12, 52.

The lateral flow testing device 82 includes a porous strip 31 divided into a sample receiving portion 83, a conjugate portion 84, a test portion 85 and a wick portion 86. The porous strip 31 is received into a base 87. A lid 88 is attached to the base 87 to secure the porous strip 31 and cover parts of the porous strip 31 which do not require exposure. The lid 88 includes a sample receiving window 89 which exposes part of the sample receiving portion 83 to define a liquid sample receiving region 90. The lid and base 87, 88 are made from a polymer such as, for example, polycarbonate, polystyrene, polypropylene or similar materials.

The base 87 includes a recess 91 into which first and second light emitters 13a, 13b are received. Each light emitter 13 may be configured as described hereinbefore. Each light emitter 13 may be an OLED, for example, a white OLED. The lid 88 includes a recess 92 into which a first pair of first and second photodetectors 14a, 15a and a second pair of first and second photodetectors 14b, 15b are received. The photodetectors 14a, 15a, 14b, 15b preferably take the form of OPDs. Each pair of first and second photodetectors 14a, 15a, 14b, 15b are preferably interdigitated in a similar way to the second layout 55 (FIG. 14A). The photodetectors 14a, 15a, 14b, 15b may be inherently sensitive to the corresponding wavelength ranges Δλ_{b}, Δλ_{c}, as in the first analytical test device 12, may include or be combined with filters 53, 54 as in the second analytical test device 52, or may include microcavities 75 as in the third analytical test device.

The first light emitter 13a and the first pair of first and second photodetectors 14a, 15a are arranged on opposite sides of a test region 29 of the porous strip 31. The second light emitter 13b and the second pair of first and second photodetectors 14b, 15b are arranged on opposite sides of a control region 30 of the porous strip 31. Slit members 93 separate the light emitters 13 from the porous strip 31 to define slits 94 which extend transversely across the width of the porous strip 31 and through which the first and second light emitters 13a, 13b illuminate the test region 29 and control region 30 respectively. For example, if the porous strip 31 extends in a first direction x and has a thickness in a third direction z, then the slits 31 extend in a second direction y. Further slit members 95 define slits 96 which separate the photodetectors 14a, 15a, 14b, 15b from the porous strip 31. The slits 94, 96 may be covered by a thin layer of transparent material to prevent moisture entering into the recesses 91, 92. Material may be considered to be transparent to a particular wavelength λ if it transmits more than 75%, more than 85%, more than 90% or more than 95% of the light at that wavelength λ. A diffuser 22 may optionally be included between each of the slits 96 and the corresponding photodetectors 14a, 5a, 14b, 15b.

A liquid sample 97 is introduced to the sample receiving portion 83 through the sample receiving window 89 using, for example, a dropper 98 or similar implement. The liquid sample 97 is transported along a liquid transport path 99 from a first end too of the porous strip 83, 84, 85, 86 and towards a second end 101 by a capillary, or wicking, action of the porosity of the porous strip 83, 84, 85, 86. The sample receiving portion 83 of the porous strip 31 is typically made from fibrous cellulose filter material.

The conjugate portion 84 has been pre-treated with at least one particulate labelled binding reagent for binding an analyte which is being tested for, so as to form a labelled-particle-analyte complex (not shown). A particulate labelled binding reagent is typically, for example, a nanometre- or micrometre-sized label particle 32 which has been sensitised to specifically bind to the target analyte. The particles 32 provide a detectable response, which is usually a visible optical response such as a particular colour, but may take other forms. For example, particles may be used which are visible in infrared, which fluoresce under ultraviolet light, or which are magnetic. Typically, the conjugate portion 84 will be treated with one type of particulate labelled binding reagent to test for the presence of one type of analyte in the liquid sample 97. However, alternate lateral flow devices may be produced which test for two or more analytes using two or more particulate labelled binding reagents concurrently. The conjugate portion 84 is typically made from fibrous glass, cellulose or surface modified polyester materials.

As a flow front of the liquid sample moves into the test portion 85, labelled-particle-so analyte complexes and unbound label particles are carried along towards the second end 101. The test portion 85 includes a test region 29 and a control region 30 which are monitored by a corresponding light emitter 13a, 13b in combination with a pair of photodetectors 14a, 15a, 14b, 15b. The test region 29 is pre-treated with an immobilised binding reagent which specifically binds the labelled-particle-analyte complex and which does not bind the unreacted label particles. As the labelled-particle-analyte complexes are bound in the test region 29, the concentration of the label particles 32 in the test region 29 increases. The concentration increase may be monitored by measuring the absorbance of the test region 29 using the corresponding light emitter 13a, 13b in combination with a pair of photodetectors 14a, 15a, 14b, 15b. The absorbance of the test region 29 may be measured once a set duration has expired since the liquid sample 97 was added. Alternatively, the absorbance of the test region 29 may be measured continuously or at regular intervals as the lateral flow strip 23 is developed.

To provide distinction between a negative test and a test which has simply not functioned correctly, a control region 30 is often provided between the test region 29 and the second end 101. The control region 30 is pre-treated with a second immobilised binding reagent which specifically binds unbound label particles and which does not bind the labelled-particle-analyte complexes. In this way, if the lateral flow testing device 82 has functioned correctly and the liquid sample 97 has passed through the conjugate portion 84 and test portion 85, the control region 30 will exhibit a change in absorbance. The absorbance of the control region 30 may be measured by the second light emitter 13b in combination with the second pair of photodetectors 14b, 15b. The test portion 85 is typically made from fibrous nitrocellulose, polyvinylidene fluoride, polyethersulfone (PES) or charge modified nylon materials. All of these materials are fibrous, and as such the sensitivity of the absorbance measurements may be improved by obtaining a corrected signal 21 as described hereinbefore.

The wick portion 86 provided proximate to the second end 101 soaks up liquid sample 97 which has passed through the test portion 85 and helps to maintain through-flow of the liquid sample 97. The wick portion 86 is typically made from fibrous cellulose filter material.

With reference to a lateral flow device 82 having an integrated analytical test device, a further advantage of the receiver side differentiated analytical test devices described by the present specification over an emission side analytical test device 1 may be explained.

FIG. 23 shows an emission side differentiated analytical test device 1 when a test region 29 of a lateral flow test strip 23 is received within the sample receiving portion 7.

An array of alternating first and second emitters 2, 3 emit light 4, 5 towards the sample receiving portion 7. The first and second emitters 2, 3 take the form of OLED devices deposited onto a transparent substrate 102. The light 4, 5 is detected on the other side of the sample receiving portion 7 by a photodetector 8 in the form of a bottom absorbing OPD deposited on a second transparent substrate 103.

In practice, it may be difficult to realise first and second emitters 2, 3 having emission spectra which do not overlap and which are arranged to alternate over small enough distances to provide substantially uniform illumination of the sample receiving portion 7 within each wavelength range. To circumvent this issue, an array of white, multi-coloured or broadband light emitters 128 may be used in combination with an array of first and second filters 53, 54. However, when filters 53, 54 are used, the thickness t of the substrate 102 means that there will be some cross-talk because the white, multi-coloured or broadband light emitters 128 emit white, multi-coloured or broadband light 129 at a range of angles.

This cross-talk may be reduced by decreasing the thickness of the substrate 102, so that a smaller fraction of white, multi-coloured or broadband light 129 from the emitters 128 underlying a first filter 53 is incident on the adjacent second filters 54, and vice versa. However, sufficiently thin glass substrates may be difficult and relatively expensive to produce, and may also be difficult to handle and deposit light emitters 2, 3 thereon. Consequently, in practice, the first and second emitters 2, 3 are deposited onto thin substrates 102 made from polymeric materials.

Referring also to FIGS. 24A to 24D, the stability of OLEDs deposited on glass and plastic substrates 102 is compared.

For an OLED on a substrate 102 formed of glass, the OLED voltage 104a, 104b and the illumination output 105a, 105b as measured by an OPD, may be observed to be substantially more stable than the analogous characteristics 106a, 106b, 107a, 107b for an OLED deposited on a substrate 102 formed of plastic. The data shown in FIGS. 24A to 24D with dashed lines 104a, 105a, 106a, 107a correspond to a first test run of approximately 36 s duration, and the data shown with solid lines 104b, 105b, 106b, 107b correspond to a second test run of approximately 6.5 s duration. The relatively poor stability of OLEDs deposited on plastic as compared to OLEDs deposited on glass may lead to undesirable noise in an emission side differentiated analytical test device 1. Such problems are of especial concern for emission side differentiated analytical test devices 1 because a difference is obtained between measurements obtained at different times, such that fluctuations in OLED output will register as a real signal when the difference is obtained.

By contrast, when the filtering is performed on the receiving side, for example using the second analytical test device 52, OLEDs providing the light emitter(s) 13 may be deposited on glass substrates to obtain the benefits of superior OLED stability. Although the thickness of the substrate 37 is still important for reducing cross-talk when the photodetectors 14, 15 are bottom absorbing OPDs 35, OPD stability when deposited on plastic is not expected to be affected in the same way as for OLEDs, in particular because OPDs are not driven with relatively high currents.

Similarly, the thickness of the encapsulation layer 51 is important for reducing cross-talk when the photodetectors 14, 15 are top absorbing OPDs 36 and the filters 53, 54 are disposed over the encapsulation layer 51. However, cross-talk may also be reduced by placing filters 53, 54 under the encapsulation layer 51 or by incorporating the filters 53, 54 into the encapsulation layer 51.

Method of Determining Weighting Coefficients

In Equations (1) to (4), weighting coefficients α, β and/or γ are used. These coefficients represent a relative weighting which accounts for differences in absolute sensitivity of the first and second photodetectors 14, 15. Such differences arise from different materials of the first and second photodetectors 14, 15 and/or geometries of the analytical test device 12, 52 overall. Consequently, once coefficient(s) α, β, γ have been determined for a particular configuration of analytical test device 12, 52, the same coefficient(s) may be used for other devices 12, 52 having the same configuration.

Weighting coefficients may be determined by modulating the light emission of the light emitter(s) 13 according to a known time dependent signal, for example, by modulating the input voltage signal. Then, the weighting coefficients may be iteratively modified so as to minimise or eliminate the introduced time dependent signal from the corrected signal 21.

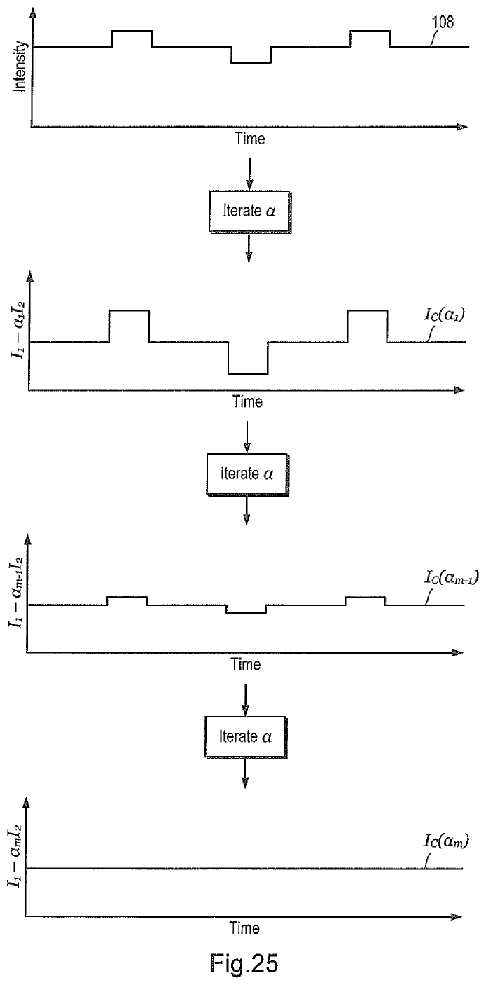

Referring also to FIG. 25, an example of determining a weighting coefficient α is shown.

An example shall be described in the case of a single pair of first and second photodetectors 14, 15 such that Equation (2) may be expressed as:

I_{C}=I₁−αI₂ (6)

In which I₁ is the signal 19 from the first photodetector, I₂ is the signal 20 from the second photodetector 15, I_{C} is the corrected signal 21 and α is a weighting coefficient. A time dependent illumination intensity 108 is generated by modulating the emission of the light emitter(s) 13 with a square wave signal.

An initial guess of the weighting coefficient, α₁, is employed to calculate a corresponding corrected signal I_{C}(α₁). Unless the initial guess α₁ is perfect, the corresponding corrected signal I_{C}(α₁) will include a component corresponding to the square wave modulation of the illumination intensity. A new weighting coefficient, α₂, is determined and used to calculate a corresponding corrected signal I_{C}(α₂). The iteration of the values of the weighting coefficient α may be conducted according to any suitable search strategy. The weighting coefficient is iterated α₂, . . . , αₘ₋₁, αₘ, until the component corresponding to the square wave modulation of the illumination intensity is removed or reduced to below a threshold magnitude in the corrected signal I_{C}(αₘ). The final, converged weighting coefficient am may then be used for calculating the corrected signal 21 for other devices having the same configuration.

Modifications

It will be appreciated that many modifications may be made to the embodiments hereinbefore described. Such modifications may involve equivalent and other features which are already known in the design, manufacture and use of analytical test devices and which may be used instead of or in addition to features already described herein. Features of one embodiment may be replaced or supplemented by features of another embodiment.

Examples have been described in which absorbance of samples 9 is determined in transmission or reflection geometries. However, the examples described herein are not limited to absorbance measurements. For example, the light emitter 13 may emit light within a first wavelength range Δλₐ which excites fluorescence by a target analyte or labelling particles, and background autofluorescence of, for example, nitrocellulose fibres of a porous strip 31. When conducting fluorescence measurements, in contrast to absorbance measurements, the first wavelength range Δλₐ ideally does not overlap, or overlaps to a minimal extent, either of the second or third wavelength ranges Δλ_{b}, Δλ_{c}. The first and second photodetectors 14, 15 may be sensitive to corresponding second and third wavelength ranges Δλ₁, Δλ₂ whether innately or using filters, chosen such that the first photodetector 14 measures the fluorescence and the second photodetector 15 measures the autofluorescence. There may be some overlap between the fluorescence wavelength range Δλ_{b} and the autofluorescence wavelength range Δλ_{c}. The advantages of being able to monitor the first and second photodetectors 14, 15 concurrently are equally applicable to fluorescence measurements.

Although examples have been described in relation to lateral flow test strips 23, the present methods and the first, second and third analytical test devices 12, 52 can also be used with other types of samples 9 with minimal modifications.

For example, referring also to FIG. 26, a fourth analytical test device 109 is shown.

The fourth analytical test device 109 includes an optical path which has a sample receiving portion 7 adapted to receive a sample 9 in the form of a container, for example a cuvette 110, containing a liquid sample 97. The absorbance of the liquid sample 97 may be measured in the second wavelength range Δλ_{b}. The limit of detection may be improved for the fourth analytical test device 109 by obtaining a corrected signal 21 as a difference between signals 19 measured by one or more first photodetectors 14 and signals 20 measured by one or more second photodetectors 15 in the same way as described hereinbefore. Similarly, the fourth analytical test device 109 may be used for fluorescence assays as described hereinbefore.

The difference in the fourth analytical test device 109 is that instead of scattering by fibres 33, the correction removes the effects of dust, scratches, smudges and so forth on the sides of the cuvette 110. Additionally, the fourth analytical test device 109 can correct for varying quantities of suspended particulate matter 111 (FIG. 29) in a liquid sample 97. For example, samples from a body of water may be obtained to check the concentrations of a dissolved pollutant. Liquid samples 97 taken at different times may include differing amounts of silt or other particles in suspension. Although samples may be left to allow suspended particulate matter 111 (FIG. 29) to sediment out, this is impractical for field-testing. The second wavelength λ₂ and associated third wavelength range Δλ_{c} may be selected to have little or no response to the pollutant, and a similar response to suspended particulate matter as the first wavelength λ₁ and corresponding second wavelength range Δλ_{b}. In this way, the hereinbefore described methods may be used to speed up the process of analysing liquid samples 97 which show inherent variability due to, for example, suspended particulate matter 97 (FIG. 29).

Referring also to FIG. 27, a fifth analytical test device 112 is shown.

The fifth analytical test device 112 includes an optical path which has a sample receiving portion 7 adapted to receive a sample in the form of an assay plate 113. The assay plate 113 includes a transparent base 114. A number of hollow cylinders 115 extend perpendicularly from the transparent base 114 to provide a number of sample wells 116, for example a first sample well 116a, second sample well 116b and so forth. Each sample well 116 may be provided with a different liquid sample 97. For example, the first sample well 116a may hold a first liquid sample 97a, the second sample well 116b may hold a second liquid sample 97b and so forth. The sample wells 116 may extend in one direction. More typically, the sample wells 116 extend in two directions to form an array. The assay plate 113 may be moved so that each sample well 116 in turn is positioned in the sample receiving portion 7 of the optical path. The hereinbefore described methods may be carried out in relation to absorbance (transmission) or fluorescence measurements in order to determine a concentration of an analyte or marker in the liquid samples 97.

Alternatively, the light emitter(s) 13 and photodetectors 14, 15 may be moved relative to the assay plate 112. The fifth analytical test device 112 may include multiple pairings of light emitter(s) 13 and corresponding photodetectors 14, 15. This can allow an entire row/column of an array of sample wells 116, or even an entire assay plate 113, to be measured concurrently.

When the sample 9 is an assay plate, the sources of inhomogeneity are not fibres 33. Similarly to the cuvette 110, dust, scratches, smudges and so forth on the assay plate 113 may cause unwanted scattering. Additionally, the interface 117 between the liquid sample 97 and the air, also sometimes referred to as the meniscus 117, can also affect the amount of light received at the photodetectors 14, 15. This can be especially pronounced when the diameter of the sample wells 116 is small. Contaminants or defects on the interior surfaces of the cylinders 115 may cause the meniscus to depart from the ideal shape, leading to inhomogeneity of the transmitted light between different sample wells 116. Even in the absence of contaminants or defects on the interior surfaces of the cylinders 115, different liquid samples 97 may have different surface tension, leading to variations in the curvature of the meniscus 117. Small variations in solute content can have disproportionate effects on surface tension. Although the scattering of light within the second and third wavelength ranges Δλ_{b}, Δλ_{c} through the meniscus 117 will have a slight wavelength dependence, the hereinbefore described correction methods can reduce the effect of inhomogeneity between different test wells 116. The correction methods can be used whether the sample wells 116 are illuminated from above, or from below.

Referring also to FIG. 28, a sixth analytical test device 118 is shown.

The sixth analytical test device 118 includes an optical path which has a sample receiving portion 7 running perpendicular to a channel 119. The channel 119 is defined by walls 120 and includes windows 121 to permit the light 17, 18 from the light emitter(s) 13 to cross the channel 119. Alternatively, if the walls 120 are transparent, windows 121 may not be needed. The channel 119 may be a pipe. Liquid flows through the channel 119 in a flow direction 122. The liquid may include suspended particulate matter ill, for example silt in river water.

The sixth analytical test device 118 may be used to analyse the concentration of a pollutant, or other analyte, which is present in the liquid flowing through the channel. In general, the quantity of particulate matter 111 suspended in liquid flowing through the channel 119 may vary with time. Inhomogeneity in the background absorbance/scattering due to suspended particulate matter 11 can have a detrimental effect on both the limit of detection and the resolution of detecting the monitored pollutant or other analyte. The second wavelength λ₉ and corresponding third wavelength range Δλ_{c} may be selected to have little or no response to the pollutant, and a similar response to suspended particulate matter as the first wavelength λ₁ and corresponding second wavelength range Δλ_{b}. In this way, the hereinbefore described methods may be used to accelerate the process of analysing flowing liquids which show inherent variability due to, for example, suspended particulate matter. Using first and second photodetectors 14, 15 is especially advantageous compared to alternating illumination of first and second emitters 2, 3 when the flow speed through the channel 119 is high.

Referring also to FIG. 29, a seventh analytical test device 123 is shown.

The seventh analytical test device 123 includes an optical path which has a sample receiving portion 7 adapted to receive a microfluidic channel 124 perpendicularly to the optical path. The microfluidic channel 124 is defined by walls 125 and contains a carrier medium, for example oil, which flows through the microfluidic channel 124 in a flow direction 126. Droplets 127 of a second liquid, usually water, contain an analyte or marker, the concentration of which within the droplet 127 is measured using the light 17 corresponding to the second wavelength range Δλ_{b}. The microfluidic channel 124 can be in the form of a length of tubing or a channel machined into polymeric material. Measurements using light 18 corresponding to the third wavelength range Δλ_{c} can be used to compensate for scattering or absorption from defects or contamination of the walls 125 of the microfluidic channel 124.

In any one of the fourth, fifth, sixth and seventh analytical test devices 109, 112, 118, 123, the first and second photodetectors 14, 15 may be configured to be sensitive to the respective second and third wavelength ranges Δλ_{b}, Δλ_{c} by one of:
Inherently different wavelength sensitivities, as in the first analytical test device 12;
First and second filters 53, 54, as in the second analytical test device 52; or
Using modified top absorbing OPDs 66 having microcavities 75 with tunable resonance wavelengths, as in the third analytical test device.

Although the advantages of using OLEDs deposited on glass substrates have been described hereinbefore, the invention may also be practised using light emitters 13 in the form of OLEDs deposited on plastic substrates.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

1. An analytical test device comprising:
one or more light emitters configured to emit light within a first range of wavelengths;
one or more first photodetectors, each first photodetector being sensitive to a second range of wavelengths around a first wavelength;
one or more second photodetectors, each second photodetector being sensitive to a third range of wavelengths around a second wavelength which is different to the first wavelength;
a correction module configured to receive signals from the first and second photodetectors and to generate a corrected signal based on a weighted difference of the signals from the first and second photodetectors;
wherein the test device is configured such that light from the light emitters reaches the first and second photodetectors via an optical path comprising a sample receiving portion.

2. An analytical test device according to claim 1, wherein a plurality of first photodetectors and a plurality of second photodetectors are disposed in an alternating pattern.

3. An analytical test device according to claim 1, wherein each first photodetector or part of each first photodetector is elongated in a first direction and each second photodetector or part of each second photodetector is elongated in the first direction;
wherein the first and second photodetectors, or parts thereof, are interdigitated in a second direction substantially perpendicular to the first direction.

4. An analytical test device according to claim 1, wherein a plurality of first photodetectors are disposed in a first lattice and a plurality of second photodetectors are disposed in a second lattice, wherein the first and second lattices are arranged to be interpenetrating.

5. (canceled)

6. An analytical test device according to claim 1, wherein the optical path is configured such that the first and second photodetectors receive light transmitted through the sample receiving portion.

7. An analytical test device according to claim 1, wherein the optical path is configured such that the first and second photodetectors receive light reflected from the sample receiving portion.

8. An analytical test device according to claim 1, wherein each first photodetector comprises a first light sensitive material which is sensitive to the second range of wavelengths and wherein each second photodetector comprises a second light sensitive material which is sensitive to the third range of wavelengths.

9. An analytical test device according to claim 1, wherein:
each first photodetector comprises a light sensitive material and a first filter, wherein the first filter is arranged to filter light arriving via the optical path, to transmit the second range of wavelengths and to attenuate the third range of wavelengths; and
each second photodetector comprises the light sensitive material and a second filter, wherein the second filter is arranged to filter light arriving via the optical path, to transmit the third range of wavelengths and to attenuate the second range of wavelengths.

10. An analytical test device according to claim 1, wherein each first photodetector comprises a light sensitive material and each second photodetector comprises the light sensitive material, further comprising:
a first filter corresponding to each first photodetector, wherein the first filter is arranged to filter light arriving via the optical path, to transmit the second range of wavelengths and to attenuate the third range of wavelengths; and
a second filter corresponding to each second photodetector, wherein the second filter is arranged to filter light arriving via the optical path, to transmit the third range of wavelengths and to attenuate the second range of wavelengths.

11. An analytical test device according to claim 1, wherein:
each first photodetector comprises a light sensitive material and a first resonant cavity configured to have a resonance wavelength within the second range of wavelengths; and
each second photodetector comprises the light sensitive material and a second resonant cavity configured to have a resonance wavelength within the third range of wavelengths.

12. An analytical test device according to claim 1, wherein each light emitter comprises an organic light emitting diode.

13. (canceled)

14. An analytical test device according to claim 1, wherein the first and second photodetectors are organic photodetectors.

15-16. (canceled)

17. An analytical test device according to claim 1, wherein the corrected signal is generated according to:
$${I}_{C} = {\sum }_{n = 1}^{N} {I}_{n}^{1} - α {\sum }_{n = 1}^{N} {I}_{n}^{2}$$
wherein I_{C} is the corrected signal, I¹ₙ is the signal from the n^{th} of N first photodiodes, I²ₙ is the signal from the n^{th} of N second photodiodes, α is a predetermined weighting coefficient and N is a real positive integer satisfying N≥1.

18. (canceled)

19. An analytical test device according to claim 1, wherein the correction module comprises a summing amplifier circuit configured to generate the corrected signal based on inputs received from the first and second photodetectors.

20. An analytical test device according to claim 1, wherein the first wavelength is within the first range of wavelengths, the second wavelength is within the first range of wavelengths, and the analytical test device is configured to measure the absorbance of a sample.

21. An analytical test device according to claim 1, wherein the first wavelength is outside the first range of wavelengths, the second wavelength is outside the first range of wavelengths, and the analytical test device is configured to measure the fluorescence of a sample.

22. An analytical test device according to claim 1, wherein the sample receiving portion of the optical path is configured to receive one of:
a lateral flow test strip;
a cuvette;
an assay well plate; or
the whole, a part, or a channel of a microfluidic device.

23-25. (canceled)

26. An analytical test device according to claim 1, further comprising:
a liquid transport path for transporting a liquid sample received proximate to an end of the liquid transport path through the sample receiving portion of the optical path.

27-28. (canceled)

29. A method of analysing a sample using an analytical test device according to claim 1, the method comprising:
receiving signals from the first and second photodetectors;
generating a corrected signal based on a weighted difference of the signals from the first and second photodetectors.

30. A method of determining one or more weighting coefficients used for determining a corrected signal in an analytical test device according to claim 1, the method comprising:
modulating the light emission intensity of the one or more light emitters according to a known time dependent signal;
iteratively modifying the one or more weighting coefficients to minimise or eliminate the time dependent signal from the corrected signal.
